(19) United States
(12) Patent Application Publication
(10) Pub. No.: US 2025/0037336 A1
(43) Pub. Date: Jan. 30, 2025

(54) AUTOMATIC OBJECT FORMATTING IN DIAGRAMS

(71) Applicant: Lucid Software, Inc., South Jordan, UT (US)

(72) Inventors: John Harrison, South Jordan, UT (US); Anthony Shui, South Jordan, UT (US); Brett Richardson, South Jordan, UT (US); Abhinav Thukral, South Jordan, UT (US); Jalen Morgan, South Jordan, UT (US)

(21) Appl. No.: 18/786,112

(22) Filed: Jul. 26, 2024

Related U.S. Application Data
(60) Provisional application No. 63/529,102, filed on Jul. 26, 2023.

(51) Int. Cl. G06T 11/60; G06T 11/20; G06T 11/40

(52) U.S. Cl. CPC G06T 11/60; G06T 11/206; G06T 11/40; G06T 2200/24

(57) ABSTRACT

An example embodiment includes a method to automatically format objects of a graphical diagram. The method includes creating one or more templates to format graphical objects. Each of the one or more templates includes one or more conditions, and each of the one or more conditions corresponds with one or more styles. The method further includes presenting the one or more templates to a user on a graphical user interface, receiving input to select a template from the one or more templates, and receiving input to create a graphical diagram that includes graphical objects on the graphical user interface. The template causes each of the graphical objects to have a style in accordance with the one or more conditions of the template. The method further includes displaying the graphical diagram to the user on the graphical user interface with each of the graphical objects formatted with a corresponding style.

### CROSS-REFERENCE TO RELATED APPLICATION

This application claims the benefit of and priority to U.S. Provisional App. No. 63/529,102 filed on Jul. 26, 2023, which is incorporated herein by reference in its entirety.

### FIELD

The embodiments discussed herein are related to automatic object formatting in diagrams.

### BACKGROUND

Unless otherwise indicated herein, the materials described herein are not prior art to the claims in the present application and are not admitted to be prior art by inclusion in this section.

Various types of data may often be represented in the form of a visualization, such as a diagram. Diagrams are useful to represent data such as, for example, workflows, sequential steps, organizational charts, network diagrams, and the like. Diagrams may be created using various software applications. However, the existing software applications for creating diagrams are cumbersome to use, and often require each node of a diagram to be created and formatted manually and individually. This not only requires a great deal of time, but also results in a lack of uniformity, thereby resulting in poor readability of diagrams. Furthermore, the existing software applications do not allow for formatting of diagram nodes in a manner unrelated to the text content of each diagram node. The existing software applications do not allow for preset rules and templates to be applied uniformly and automatically to every diagram node based on certain conditions and criteria.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method to format graphical objects includes receiving input to create a style template to automatically format graphical objects on a graphical user interface, includes receiving first input to designate a condition and receiving second input to designate a style to apply to any graphical object that satisfies the condition. The method includes receiving input to create a graphical diagram that includes multiple graphical objects on the graphical user interface. The method includes automatically applying the style template to automatically format graphical objects that satisfy the condition, including automatically formatting a first graphical object of the multiple graphical objects that satisfies the condition to have the style. The method includes displaying the graphical diagram on the graphical user interface with each graphical object that satisfies the condition, including the first graphical object, formatted with the style.

In another example embodiment, a method to format graphical objects includes displaying multiple graphical objects on a graphical drawing canvas. The method includes displaying multiple style templates that may be applied to the multiple graphical objects, each of the style templates having a different predefined style. The method includes receiving input to select a first style template of the multiple style templates. The method includes, in response to receiving the input to select the first style template, automatically updating a style of a first graphical object of the multiple graphical objects to match a predefined style of the first style template.

In another example embodiment, a method to automatically format objects of a graphical diagram includes creating one or more templates to format graphical objects, where each of the one or more templates includes one or more conditions, and each of the one or more conditions corresponds with one or more styles. The method further includes presenting the one or more templates to a user on a graphical user interface, receiving input to select a template from the one or more templates, and receiving input to create a graphical diagram that includes graphical objects on the graphical user interface. The template causes each of the graphical objects of the graphical diagram to have a style in accordance with the one or more conditions of the template. The method further includes displaying the graphical diagram to the user on the graphical user interface with each of the graphical objects being formatted with a corresponding style.

In another example embodiment, a method to display a graphical diagram includes receiving input to create one or more templates to format graphical objects on a graphical user interface, where each of the one or more templates includes one or more conditions, and each of the one or more conditions corresponds with one or more styles. The method further includes receiving input to select a template from the one or more templates and receiving input to create a graphical diagram that includes graphical objects on the graphical user interface. The template causes each of the graphical objects to have a style in accordance with the one or more conditions of the template. The method further includes displaying the graphical diagram on the graphical user interface with each of the graphical objects being formatted with a corresponding style.

In another example embodiment, a non-transitory computer-readable medium has computer-readable instructions stored thereon that are executable by a processor to perform or control performance of operations. The operations include receiving input to create one or more templates to format graphical objects on a graphical user interface, where each of the one or more templates include one or more conditions, and each of the one or more conditions corresponds with one or more styles. The operations include receiving input to select a template from the one or more templates. The operations include receiving input to create a graphical diagram that includes graphical objects on the graphical user interface, where the template causes each of the graphical objects to have a style in accordance with the one or more conditions of the template. The operations include displaying the graphical diagram on the graphical user interface with each of the graphical objects being formatted with a corresponding style.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 depicts a block diagram of an example operating environment that includes a server and one or more client devices;

FIG. 2 depicts a graphical user interface of an application;

FIG. 3A depicts a graphical user interface of an application with an open menu;

FIG. 3B depicts a graphical user interface of an application with another open menu;

FIGS. 3C-3D depict another graphical user interface of an application;

FIG. 4 depicts a graphical user interface of an application with a conditional formatting rule-creation pop-up window open;

FIG. 5A depicts a graphical user interface of an application with example selections of a conditional formatting rule-creation pop-up window;

FIG. 5B depicts the graphical user interface of the application of FIG. 5A with alternative example selections of the conditional formatting rule-creation pop-up window of FIG. 5A;

FIGS. 5C and 5D depict the graphical user interface of the application of FIG. 5A with alternative example selections of the conditional formatting rule-creation pop-up window of FIG. 5A;

FIG. 5E depicts another graphical user interface of an application with example selections of a conditional formatting rule-creation pop-up window;

FIG. 6 depicts a graphical user interface of an application with example selections of a conditional formatting rule-creation pop-up window applied to a graphical object;

FIG. 7A depicts a diagram created without automatic object formatting in an application;

FIG. 7B depicts a diagram created with automatic object formatting in an application;

FIG. 8 depicts a diagram created with automatic object formatting in an application;

FIG. 9 depicts a Venn diagram created with automatic object formatting in an application;

FIG. 10 depicts a diagram created with automatic object formatting in an application;

FIG. 11A depicts a Sankey diagram created with automatic object formatting in an application;

FIG. 11B depicts another Sankey diagram created with automatic object formatting in an application;

FIG. 12 depicts a flowchart of a method to create a diagram with automatic object formatting in an application;

FIG. 13 depicts a flowchart of another method to create a diagram with automatic object formatting in an application;

FIG. 14 is a block diagram illustrating an example computing device that is arranged to generate and display graphical diagrams via automatic object formatting,

all arranged according to at least one embodiment of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION OF EXAMPLE EMBODIMENTS

Some embodiments herein relate to a software application that can create diagrams by applying conditional formatting throughout a diagram and to every node of the diagram consistently and uniformly, based not only on the text content of the diagram, but alternatively or additionally based on other preset templates, rules, conditions, and criteria unrelated merely to text.

In more detail, aspects of the present disclosure provide methods, processing systems, and computer-readable mediums to automatically format objects in diagrams. A diagram is typically a graphical representation of data having multiple objects, i.e., nodes. Each node in a diagram typically includes a particular value, instruction, or data point, often depicted in the form of text enclosed by a shape. Often, it is desirable to apply stylistic formatting to the entire diagram, and/or to each node of the diagram, such as by choosing a shape, a color, font size and style, line width and style, and other formatting as desired.

Embodiments of the present disclosure apply formatting to a diagram and to each and every node of the diagram automatically, uniformly, and consistently based upon rules, conditions, and criteria, which may be preset in the software application and customized or modified by a user, so that the user is not required to format each diagram node individually and manually.

The conditional formatting described herein may result in improved readability of diagrams and increased speed and ease of creating diagrams. Furthermore, embodiments of the present disclosure as described herein may allow formatting of diagram nodes in a manner unrelated to the text content of each diagram node, but rather, based on a preset condition that is applied to the diagram before the diagram yet contains data or text. Thus, the present disclosure as described herein may allow for preset rules and templates to be applied uniformly and automatically to every diagram node based on certain conditions and criteria.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

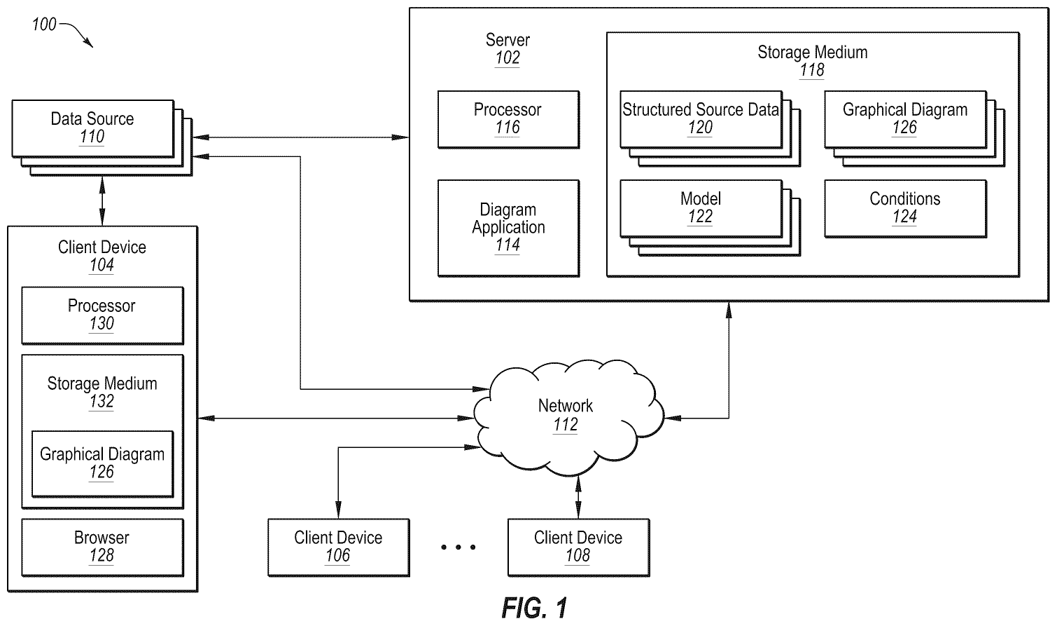

FIG. 1 is a block diagram of an example operating environment 100 that includes a server 102 and one or more client devices 104, 106, 108, arranged in accordance with at least one embodiment of the present disclosure. The server 102 and/or the client devices 104, 106, 108 may be configured to generate and display graphical diagrams or visualizations that include graphical objects or nodes formatted according to specified conditions, i.e., via automatic object formatting. The terms “graphical diagram” and “visualization” are used interchangeably herein. The terms “object” and “node” are used interchangeably herein to mean one object or node of a diagram having more than one object or node. In some embodiments, the server 102 and/or the client devices 104, 106, 108 may be configured to uniformly apply style formatting to each graphical object or node, as well as to entire diagrams.

The structured source data may be received from one or more data sources 110. Each of the data sources 110 may include, for example, a human resources (HR) system or database such as BAMBOOHR or WORKDAY; a customer relationship management (CRM) system such as SALESFORCE.COM or MICROSOFT DYNAMICS CRM; a spreadsheet for HR, e.g., with names, pictures, and/or a reporting structure for employees of an entity; a custom internal logging system; a floorplan database (e.g., with employee office/workstation assignments); a cloud infrastructure provider such as AWS, GOOGLE CLOUD, or MICROSOFT AZURE; a database schema (e.g., to generate Entity Relationship Diagrams); a service-oriented architecture; physical network discovery tools; custom-built technical systems that can be modeled similar to a network; or other suitable data source and/or data collection. Data source 110 may alternatively or additionally be manually created, in whole or in part. In some embodiments, input data, such as data from an Excel spreadsheet, or other data or data points may be manually entered by a user into a diagram node or object. The data in each of the data sources 110 may have a specific format, which may be different and/or the same from one data source 110 to another. Some example data formats include text, proprietary formats, Structured Query Language (SQL), and JavaScript Object Notation (JSON).

The structured source data may identify two or more nodes or other entities and relationships among them. For instance, the structured source data may identify employees, executives, owners and/or other personnel of a company as well as their relationships to each other, such as relative ranks and organization into one or more divisions, departments, or other logical units. As another example, the structured source data may identify various compute nodes, storage nodes, database nodes, networking nodes, and/or other entities deployed by a customer in AWS as well as relationships among the entities, such as specific ports over which specific nodes can communicate. As another example, the structured source data may identify databases and tables within databases and/or other entities in a database schema as well as relationships among the entities, such as foreign and/or primary keys.

Each graphical diagram may graphically represent one or more of the nodes using one or more graphical objects. In particular, each node may be represented by or otherwise associated with a set of one or multiple graphical objects. For example, compute nodes and database nodes of AWS structured source data may each be represented by a corresponding graphical node in a graphical diagram. As another example, a node of an employee or other individual in an organization may be graphically represented by a box or other shape outline (e.g., a first graphical object), a photo of the employee (e.g., a second graphical object), text (e.g., a third graphical object) that may include the employee's name, office location, and/or other information, and/or a connector (e.g., a fourth graphical object) that indicates the employee's supervisor or manager or other individual the employee reports to.

The server 102 and/or the client devices 104, 106, 108 may be configured to automatically generate graphical diagrams based on the structured source data 120. The graphical diagrams may be generated based on contract maps. Alternatively or additionally, automatically-generated graphical diagrams or graphical objects therein may be customized by application of conditional formatting, i.e., automatic object formatting, which may be implemented via preset rules, conditions, criteria, and templates, as specified by the application and customizable by a user, as discussed herein. In some embodiments, updates made to the graphical drawings, e.g., to graphical objects within the graphical drawings that represent the nodes, may be propagated back to the structured source data in some circumstances. Alternatively or additionally, the server 102 and/or the client devices 104, 106, 108 may be configured to apply one or more reversible data transforms to the structured source data when generating graphical diagrams. Additional details regarding contract maps, customization of graphical diagrams, conditional formatting, updating structured source data, and reversible data transforms are disclosed in the following U.S. patent documents which are incorporated herein by reference in their entireties: U.S. Pat. No. 10,860,602 (U.S. application Ser. No. 16/024,533, filed Jun. 29, 2018), U.S. Pat. No. 10,860,603 (U.S. application. Ser. No. 16/024,544, filed Jun. 29, 2018), U.S. Pat. No. 11,232,139 (U.S. application Ser. No. 16/024,551, filed Jun. 29, 2018), and U.S. Pat. No. 11,144,516 (U.S. application Ser. No. 16/796,757, filed Feb. 20, 2020).

Although one server 102 and three client devices 104, 106, 108 are illustrated in FIG. 1, the operating environment 100 may more generally include one or more servers 102 and one or more client devices 104, 106, 108. In these and other embodiments, the operating environment 100 may include other servers and/or devices not illustrated in FIG. 1.

The operating environment 100 may additionally include a network 112. In general, the network 112 may include one or more wide area networks (WANs) and/or local area networks (LANs) that enable the server 102, the client devices 104, 106, 108, and the data sources 110 to communicate with each other. In some embodiments, the network 112 may include the Internet, including a global internetwork formed by logical and physical connections between multiple WANs and/or LANs. Alternately or additionally, the network 112 may include one or more cellular radio frequency (RF) networks and/or one or more wired and/or wireless networks such as 802.xx networks, Bluetooth access points, wireless access points, Internet Protocol (IP)-based networks, or other wired and/or wireless networks. The network 112 may also include servers that enable one type of network to interface with another type of network.

In general, the server 102 may host a web-based diagram application (hereinafter application) 114 that allows the client devices 104, 106, 108 to generate and display graphical diagrams that utilize automatic object formatting, i.e., conditional formatting, where the graphical objects or nodes are formatted and styled automatically and consistently according to conditions, rules, criteria, and/or templates, provided by the application and customizable by a user. In other embodiments, the application 114 may include a non-web-based application but may generally be described herein as a web-based application for simplicity.

The server 102 may additionally include a processor 116 and a storage medium 118. The processor 116 may be of any type such as a central processing unit (CPU), a microprocessor (μP), a microcontroller (μC), a digital signal processor (DSP), or any combination thereof. The processor 116 may be configured to execute computer instructions that, when executed, cause the processor 116 to perform or control performance of one or more of the operations described herein with respect to the server 102.

The storage medium 118 may include any non-transitory computer-readable medium, including volatile memory such as random access memory (RAM), persistent or non-volatile storage such as read only memory (ROM), electrically erasable and programmable ROM (EEPROM), compact disc-ROM (CD-ROM) or other optical disk storage, magnetic disk storage or other magnetic storage device, NAND flash memory or other solid state storage device, or other persistent or non-volatile computer storage medium. The storage medium 118 may store computer instructions that may be executed by the processor 116 to perform or control performance of one or more of the operations described herein with respect to the server 102.

The storage medium 118 may additionally store one or more sets of structured source data 120, one or more models 122, automatic object formatting conditions 124 (“Conditions” in FIG. 1), and/or one or more graphical diagrams 126. Each set of structured source data 120 may be imported from a corresponding one of the data sources 110 or the user may manually enter each data point. The structured source data 120 may be imported over the network 112 or directly from the corresponding data source 110 if a direct connection exists. The graphical diagrams 126 may be generated based on input received from users at the client devices 104, 106, 108 and may include some or all of the nodes or other entities represented in the corresponding set of structured source data 120 and/or in the corresponding model 122 derived from the corresponding set of structured source data 120.

Some graphical diagrams 126 may have a large number of nodes, such as hundreds or even thousands of nodes, the extent of and relationships between which may be so detailed that it would be extremely complex and time-consuming to apply stylistic formatting to each node individually and to the entire diagram. Even if a user expended the time to apply stylistic formatting to each node individually, the formatting would likely not be consistent and uniform throughout. Thus, a user may desire to apply stylistic formatting to an entire graphical diagram (or a subset thereof) based upon the type of diagram being created and/or other criteria, and not necessarily based upon each data point or the content of each data point, where the stylistic formatting would more desirably be applied via a predetermined style template having predetermined object formatting conditions 124 provided by the application, and where the stylistic formatting can be customized according to the conditions 124, such as if-else conditions, or if-then-else conditions. The conditions 124 may be predetermined in a template within the application, and/or the conditions 124 can be modified or set by the user. The conditions 124 may include a set of rules that the stylistic formatting of the graphical diagrams 126 will follow, such that when conditions 124 are met within a node, a particular predefined style would be applied to that node.

In some embodiments, the server 102 may be configured to cooperate with the client devices 104, 106, 108 to allow the client devices 104, 106, 108 to generate and display graphical diagrams 126. Generating and displaying graphical diagrams 126 may include generating and/or displaying the graphical diagrams 126 based directly on the structured source data 120 and/or based on the models 122 derived from the structured source data 120. In these and other embodiments, client devices 104, 106, 108 may use a corresponding application or app, such as a browser 128, to generate the graphical diagrams 126, which may be displayed on a display of the corresponding client device 104, 106, 108.

Accordingly, each of the client devices 104, 106, 108 may execute an application, such as the browser 128, configured to communicate through the network 112 with the server 102. The browser 128 may include an Internet browser or other suitable application to communicate through the network 112 with the server 102. The browser 128 may generate, download and/or interact with structured source data 120 and/or graphical diagrams 126. Each of the client devices 104, 106, 108 may include a desktop computer, a laptop computer, a tablet computer, a mobile phone, a smartphone, a personal digital assistant (PDA), a wearable device (e.g., a smart watch), or another suitable client device.

Each of the client devices 104, 106, 108 may additionally include a processor and a storage medium, such as a processor 130 and a storage medium 132 as illustrated for the client device 104 in FIG. 1. Each of the other client devices 106, 108 may be similarly configured. Similar to the processor 116 of the server 102, the processor 130 may be of any type such as a CPU, a μP, a μC, a DSP, or any combination thereof. The processor 130 may be configured to execute computer instructions that, when executed, cause the processor 130 to perform or control performance of one or more of the operations described herein with respect to the client device 104 and/or the browser 128.

Similar to the storage medium 118 of the server 102, the storage medium 132 of the client device 104 may include any non-transitory computer-readable medium, including volatile memory such as RAM, persistent or non-volatile storage such as ROM, EEPROM, CD-ROM or other optical disk storage, magnetic disk storage or other magnetic storage device, NAND flash memory or other solid state storage device, or other persistent or non-volatile computer storage medium. The storage medium 132 may store computer instructions that may be executed by the processor 130 to perform or control performance of one or more of the operations described herein with respect to the client device 104 and/or the browser 128. The storage medium 132 may additionally store, at least temporarily, a graphical diagram 126, automatic object formatting conditions 124, some of a corresponding set of structured source data 120 or model 122, and/or other content obtained from the server 102 and/or generated locally on the client device 104.

Embodiments described herein are not limited to using a browser to communicate with the server 102 to generate and display graphical diagrams 126 and group and collapse graphical objects therein. For example, rather than or in addition to a browser, the client devices 104, 106, 108 may include a native application as are often used on client devices such as mobile devices including smartphones and tablet computers. Accordingly, embodiments described herein generally include generating and displaying graphical diagrams and applying automatic object formatting to the diagram and its objects or nodes according to conditions, using a browser, a native application, or another suitable application on the client devices 104, 106, 108.

Applying styles to the graphical diagram 126 may be achieved automatically according to the automatic object formatting conditions 124. For instance, the user may navigate a UI on the client device 104 to open a conditional formatting rule-creation pop-up window or other window or interface element(s), where the user can create and set conditions 124 for stylistic formatting that are to be applied throughout the entirety of the diagram and to each node therein, or select a template of conditions 124 that have been predetermined and provided by the application. The template conditions 124 may further be customized by the user. The application can provide, or the user can create, templates for a variety of graphical diagram needs—for example, a user can input a template with a color scheme that matches an organization's theme colors; as another example, the application can provide a template for a diagram type, such as a template for a Venn diagram, a template for a Sankey diagram, yet another template for a flowchart, and yet another template for an organizational chart. The conditional stylistic formatting may then automatically be applied to all graphical objects representing nodes that meet the set conditions 124. In some examples, graphical objects that represent nodes may be connected by lines or other connectors to indicate relationships between the nodes. The conditions 124 thus may apply conditional stylistic formatting to the connectors or lines as well. In at least one embodiment, the user may manually override the template style for one or more graphical objects.

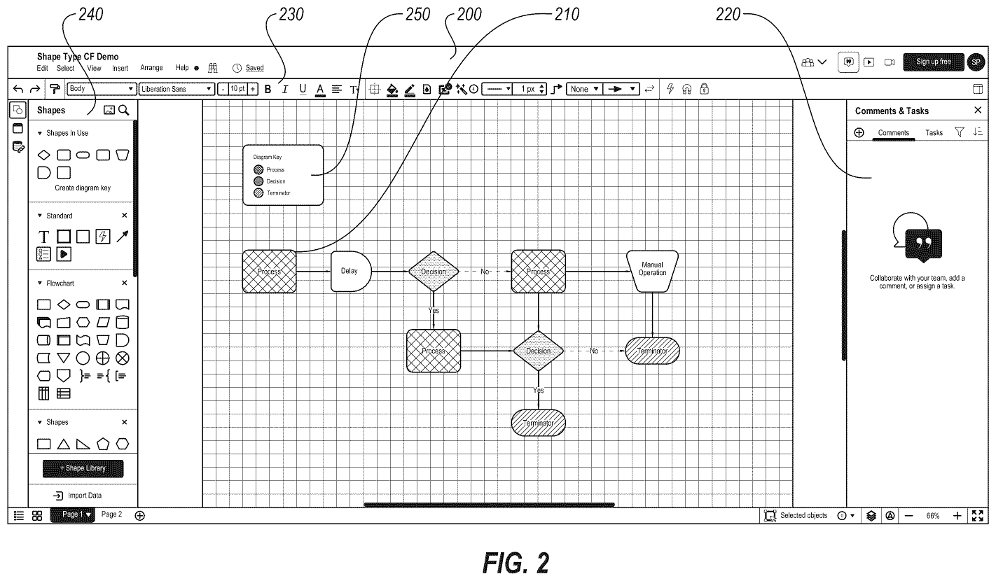

FIG. 2 depicts a graphical user interface (UI) 200 of an application to generate graphical diagrams 210 according to at least one embodiment of the present disclosure. The UI 200 may be provided by the browser 128 and/or the diagram application 114 of FIG. 1. For instance, the browser 128 in FIG. 1 in cooperation with the diagram application 114 of FIG. 1 may present the UI 200 of FIG. 2 to a user through a display of the client device 104 in FIG. 1. The UI 200 may include a comment section 220 where multiple users can collaborate and leave comments regarding the diagram 210. The UI 200 may include toolbar 230 having tools to apply styles to the diagram 210. Conditions 124 of FIG. 1 may automatically define the styles in toolbar 230. The UI 200 may also include sidebar 240 with additional tools to apply styles to diagram 210, and Conditions 124 of FIG. 1 may also automatically define the styles in sidebar 240. Conditions 124 of FIG. 1 may automatically create the diagram key 250.

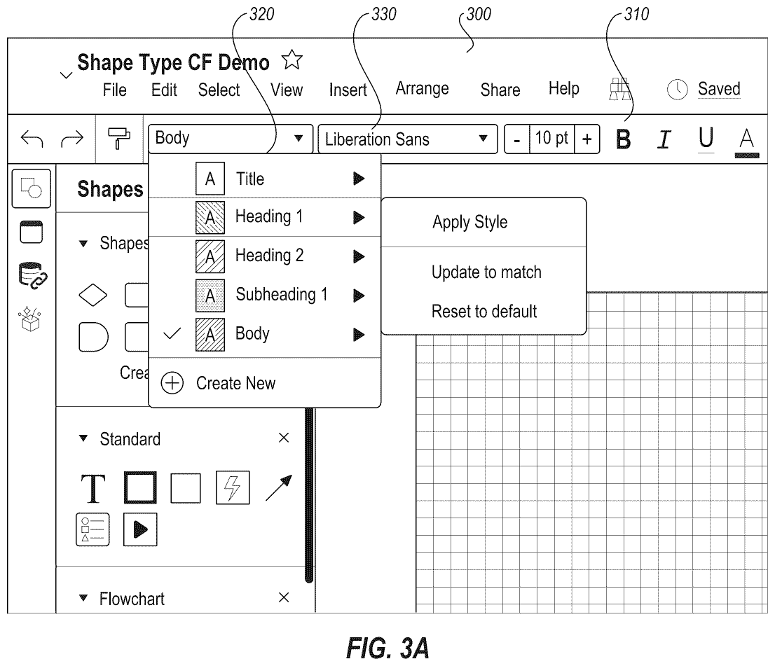

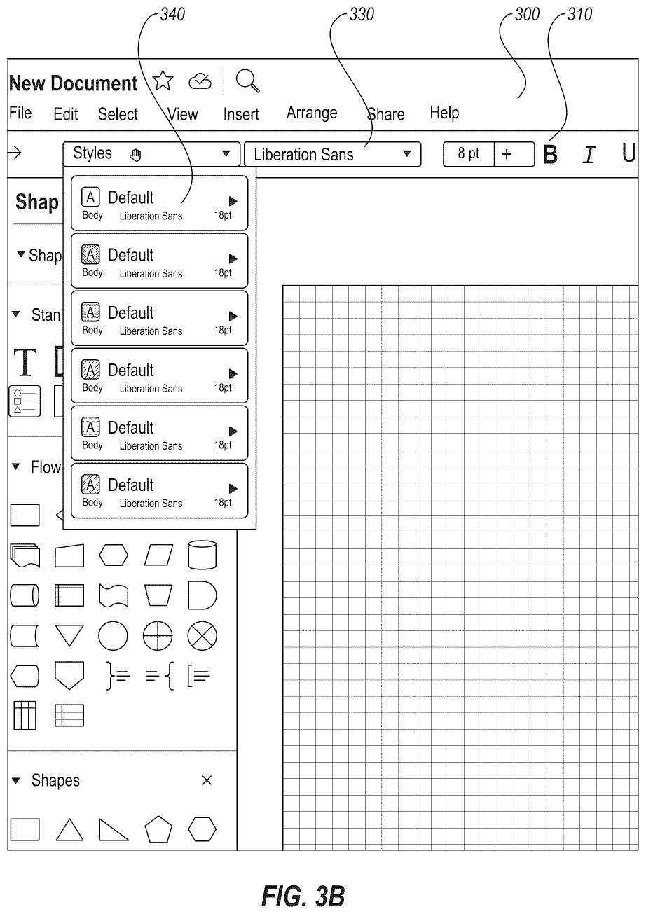

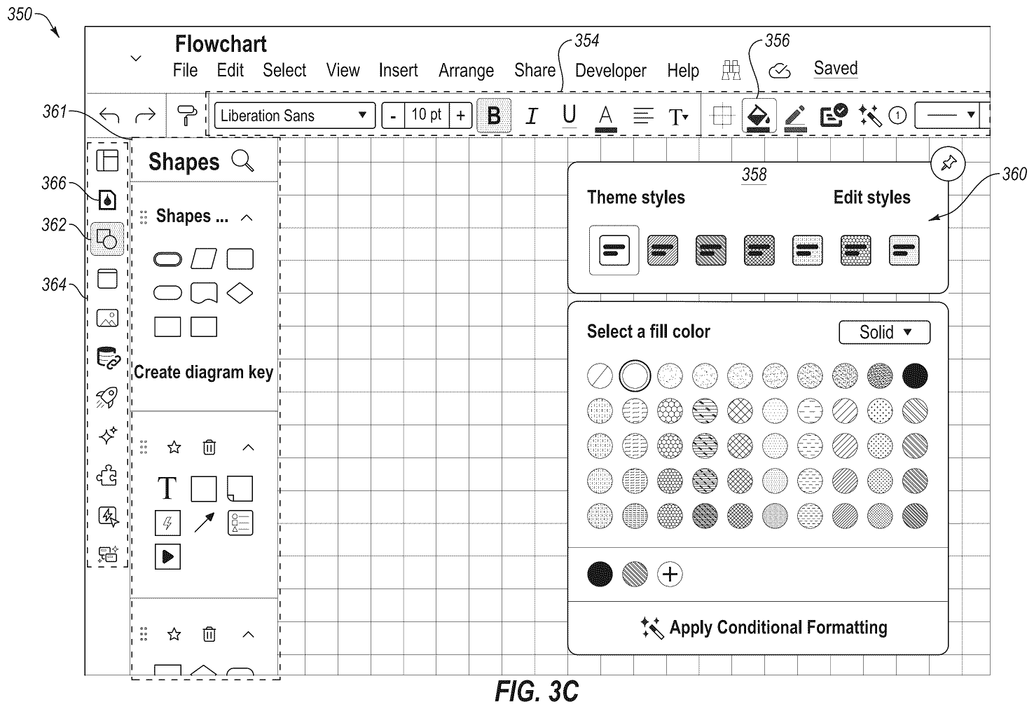

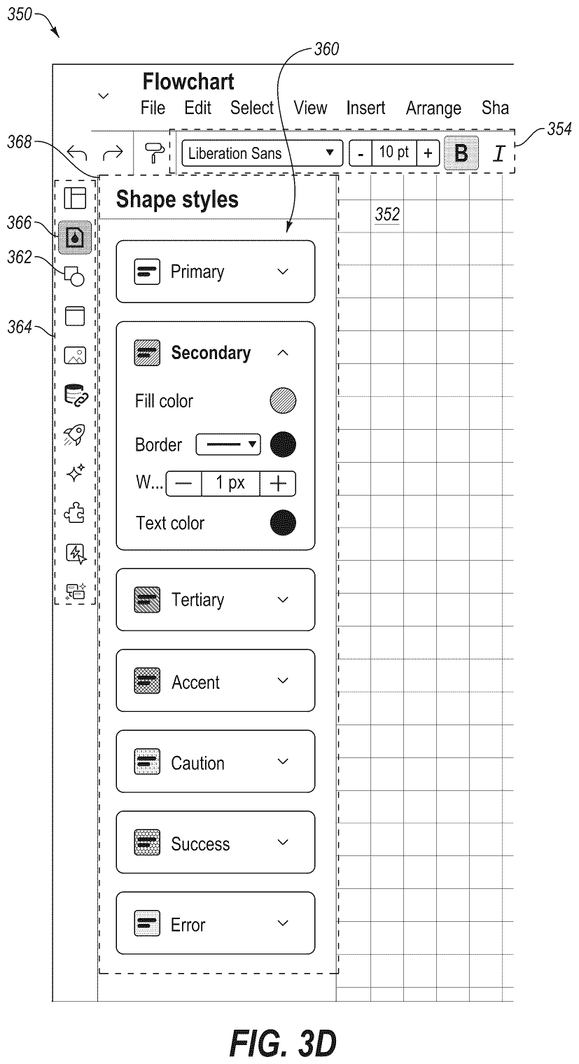

FIG. 3A depicts a graphical user interface 300 of an application with an open menu 320 within toolbar 310, according to at least one embodiment of the present disclosure. Conditions 124 of FIG. 1 may automatically define the styles in toolbar 310 and the underlying styles within the menu 320, and other menus, such as closed menu 330, of toolbar 310. By opening the menu 320 and making selections therein, or by opening the other menus such as menu 330, a user can override and customize the conditions 124, as in FIG. 1, that are predetermined by the application according to predefined templates, where each template is a set of conditions 124.

A user can select a template within the application depending on the user's desired graphical diagram type. For example, a user can select a template for “Organizational Chart,” if the user desires to create a graphical diagram to represent a hierarchy of individuals within an organization. The “Organizational Chart” template may apply a set of conditions 124 to the entire graphical diagram, by preselecting some or all styles within some or all menus within the toolbar and sidebar(s) of the application. Thus, the application may automatically apply a style format to each graphical object or node, depending on what the object or node represents, i.e., if an object or node meets certain conditions. For example, a node that represents, i.e., meets the condition of, “CEO” may have a different style, e.g., shape and color, than a node that represents “manager,” and yet a different style from a node that represents a lower level employee. As another example, graphical objects having a particular meaning, such as a decision object, a terminator object, or a process object, can still be formatted via automatic object formatting, independent of whether the graphical object has any data or text.

For example, if the condition “CEO” is met, the graphical object can be rectangular and red. If the condition “CEO” is not met, the graphical object can be circular and white. Or, if the “CEO” condition is not met, but the “manager” condition is met, then the graphical object can be triangular and yellow. In other words, a first condition can be checked, and if not met, a second condition can then be checked; if the first condition is met, the first condition may be applied, and the second condition may not be checked. Thus, the conditions 124 of FIG. 1 are programmed to follow “if-then” or “if-then-else” logic statements, or even “if-then-else-else” logic statements, and so on. The conditions can be programmed to be checked simultaneously and follow an order of precedence, e.g., two conditions can be checked for at once, and if both are met, only the condition with higher precedence will be applied. A user can also create and save its own templates, i.e., a set of conditions 124 as in FIG. 1.

In this manner, a user can create graphical objects or nodes that have a preset style, where the style is not dependent upon the source data or text within the object or node. As an alternate example, a style formatting approach that does depend on source data or text within the object or node would only apply a style to the graphical object after the text, e.g., “CEO,” is typed or data point is entered into the object or node. Conversely, automatic object formatting based upon predetermined conditions may apply stylistic formatting to a graphical object or node, and/or to connecting lines or connectors, based upon properties of the graphical object or node or a graphical object or node type, and unrelated to text or data within the object or node. It should be understood, however, with the benefit of the present disclosure, that an application according to the disclosure provided herein may perform both methods of formatting, exclusively or simultaneously—automatic object formatting based upon conditions, or object formatting based upon the text or data of the object, or both, optionally as desired and selected by the user. Automatic object formatting may uniformly format some, many, or up to all, graphical object properties, such as size, shape, color, etc., and/or the style, length, shape, and/or other properties of diagram connectors and connector lines, so that graphical diagrams are created with ease of effort, improved speed, and having improved readability and uniform appearance. Automatic object formatting may alternatively or additionally allow a user to make stylistic changes that apply consistently to an entire diagram, rather than being required to manually change the style of each individual graphical object or node, which may be particularly helpful for large and complex graphical diagrams. FIG. 3B depicts a graphical user interface 300 of an application with another open menu 340, according to at least one embodiment of the present disclosure, demonstrating an example manner in which object formatting styles can be based upon conditions. For example, a diagram that represents a workflow having possible outcomes, such as “positive” or “negative” outcomes, can automatically apply stylistic formatting to diagram nodes matching each of those outcomes: a “positive” outcome may style the diagram node in green color, and a “negative” outcome may style the diagram node in “red” color. Other conditions can be specified to style diagram nodes in other colors, other shapes, other sizes, and more.

FIGS. 3C-3D depict another graphical user interface 350 of an application, according to at least one embodiment of the present disclosure. The graphical user interface 350 includes a drawing canvas 352 (similar to the drawing canvas shown but not labeled in FIGS. 3A-3B) on which graphical objects (not shown in FIG. 3C) may be arranged to create a graphical diagram. In some embodiments, the graphical user interface 350 includes a toolbar 354 with various formatting options, similar to FIG. 3A, and/or a styles icon 356 (FIG. 3C). Referring to FIG. 3C, selection of the styles icon 356 (or other suitable input) may open a styles menu 358 from which a user may select any one of various templates 360 (e.g., styles templates) to apply to graphical objects within the drawing canvas 352. Conditions 124 (FIG. 1) associated with each of the templates 360 may be automatically applied to all of the graphical objects on the drawing canvas 352 in response to selection of the corresponding one of the templates 360. Alternatively or additionally, the conditions 124 may be automatically applied only to one or more graphical objects selected at the time the desired template 360 is selected. Alternatively or additionally, the style of one or more graphical objects may be manually overridden (e.g., using the toolbar 354) and/or graphical objects that already have a manually set style may not have their style altered when a given one of the templates 360 is selected. In some embodiments, the styles menu 358 may include an option to edit the templates, e.g., by selection of the “Edit styles” link within the menu 358, which may open a menu to edit one or more of the templates 360. An example of such a window in the form of a toolbox is illustrated in and described with respect to FIG. 3D.

As illustrated in FIG. 3C, the graphical user interface 350 may include a shapes toolbox 361 from which a user may select shapes, e.g., to drag and drop onto the canvas 352 from the shapes toolbox 360. The shapes toolbox 361 may be opened beside the drawing canvas 352 in response to, e.g., selection of a corresponding toolbox icon 362 from a set of available toolbox icons 364 that also includes a styles toolbox icon 366. Selection of a given one of the toolbox icons 364 may open a corresponding toolbox, e.g., in place of the shapes toolbox 361. For example, selection of the styles toolbox icon 366 may open a styles toolbox 368 as illustrated in FIG. 3D. Alternatively or additionally, selection of the “Edit styles” link or other user interface element from within the menu 358 of FIG. 3C may open the styles toolbox 368.

With the styles toolbox 368 open, a user may select the dropdown arrow next to each of the templates 360 to view and optionally edit the editable features of the template. In FIG. 3D, for instance, the dropdown arrow next to the “Secondary” template 360 has been selected and the editable features include fill color, border style (e.g., solid, dot dot, dash dot, dash dash, etc.), border weight, and text color. In some embodiments, editing a given one of the templates 360 automatically applies the corresponding changes to any graphical objects that have that template applied. For example, suppose a first one of the templates 360 is applied to a first set of graphical objects on the canvas 352 and a second one of the templates 360 is applied to a second set of graphical objects on the canvas 352. If the fill color of the first one of the templates 360 is changed from red to green, the fill color of the first set of graphical objects may be automatically changed from red to green in response to editing the first one of the templates 360 in this manner. Similarly, If the border style of the second one of the templates 360 is changed from solid to dot dash, the border style of the second set of graphical objects may be automatically changed from solid to dot dash in response to editing the second one of the templates 360 in this manner.

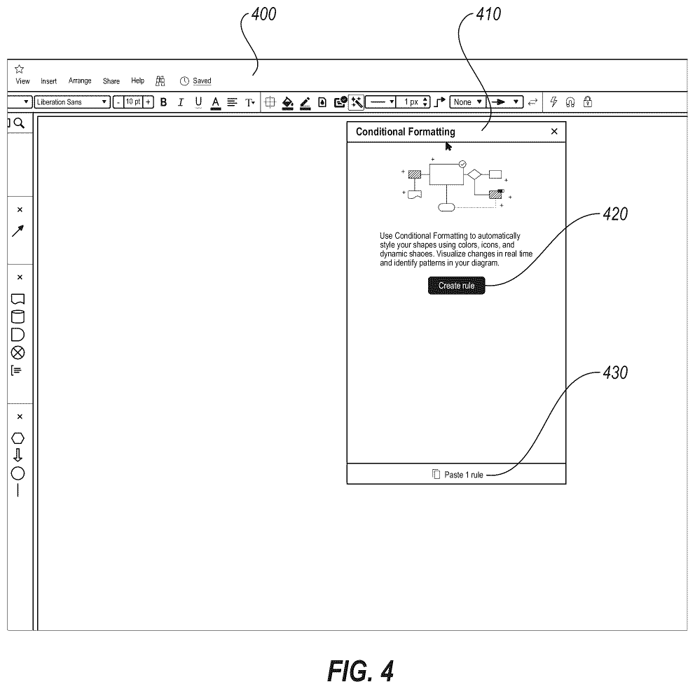

FIG. 4 depicts a graphical user interface 400 of an application with a conditional formatting rule-creation pop-up window (“conditional formatting window”) 410 open, according to at least one embodiment of the present disclosure. Although an application in accordance with the disclosure described herein may include predefined templates, i.e., sets of conditions, for multiple diagram types, a user may also create its own template, or modify a predefined template, by creating new or modifying preset rules (conditions). The user can select the “create rule” button 420, or the user can copy a rule (condition) from another instance of the application and paste it into this instance using the “paste rule” button 430. The user can therefore save rules (conditions) for use in future sessions of use of the application.

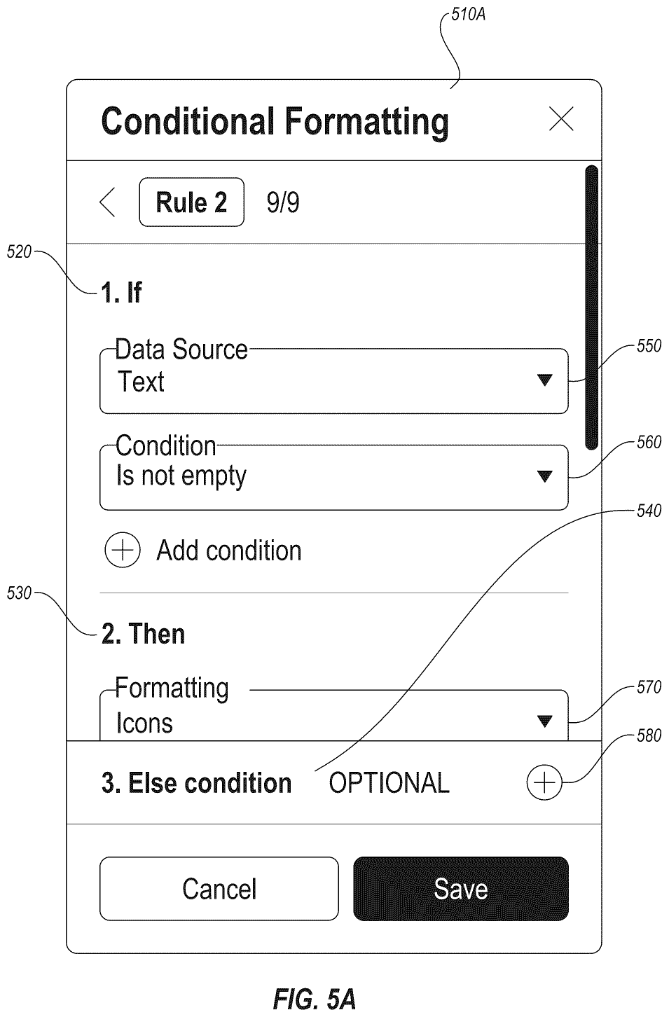

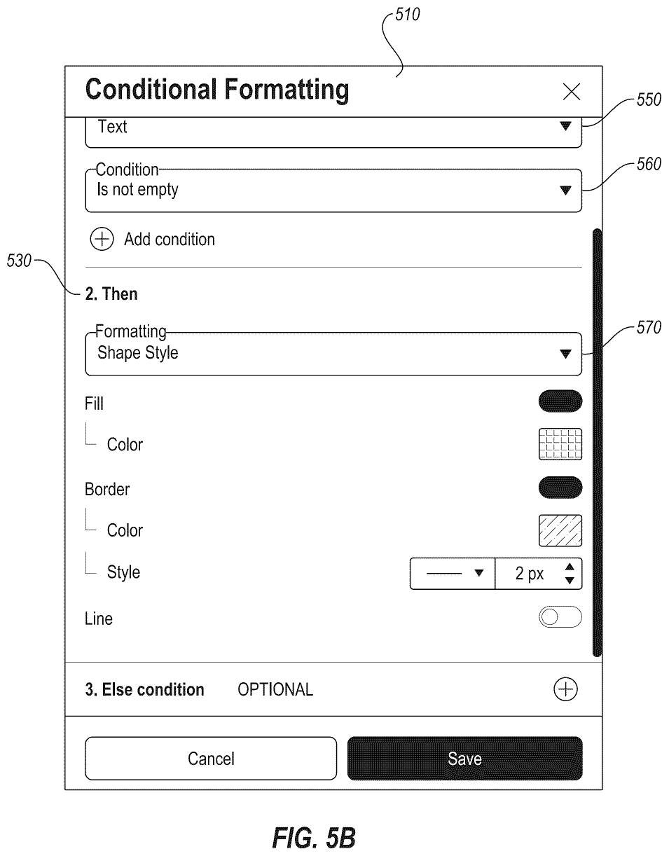

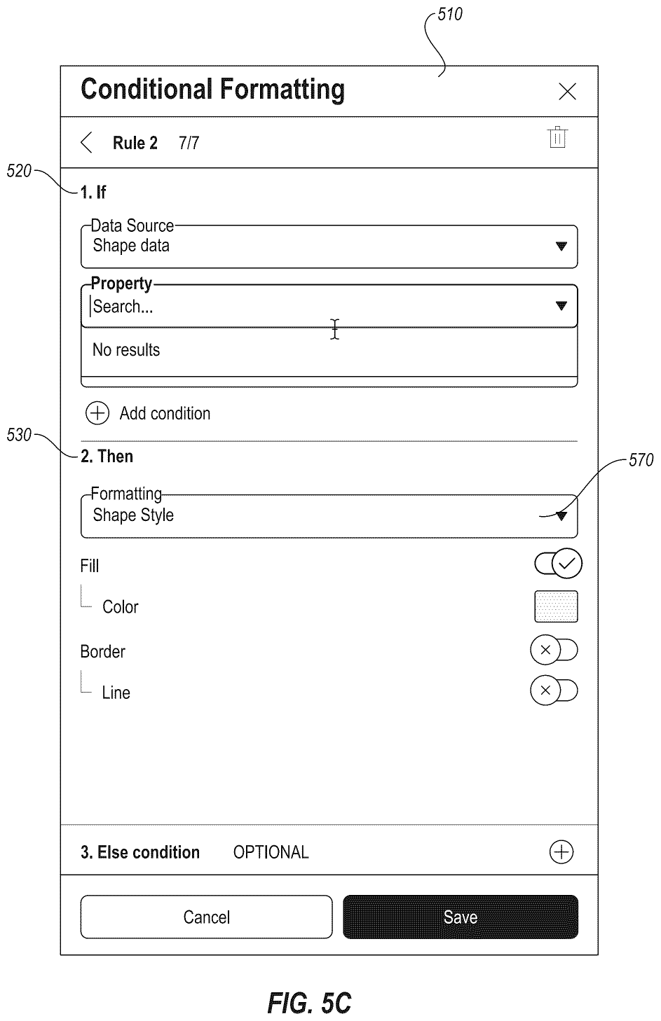

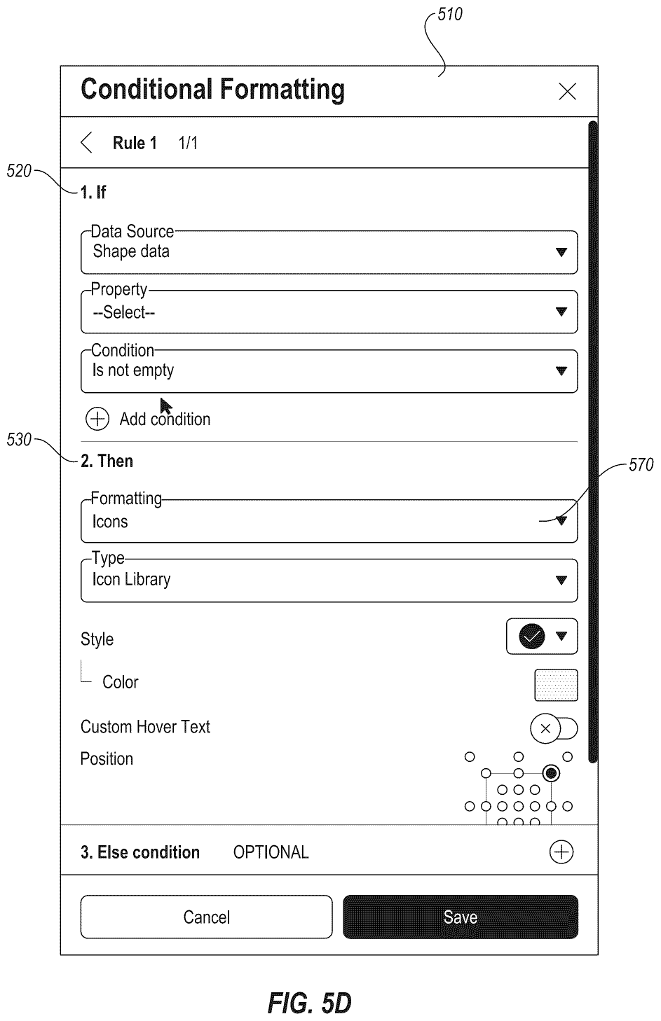

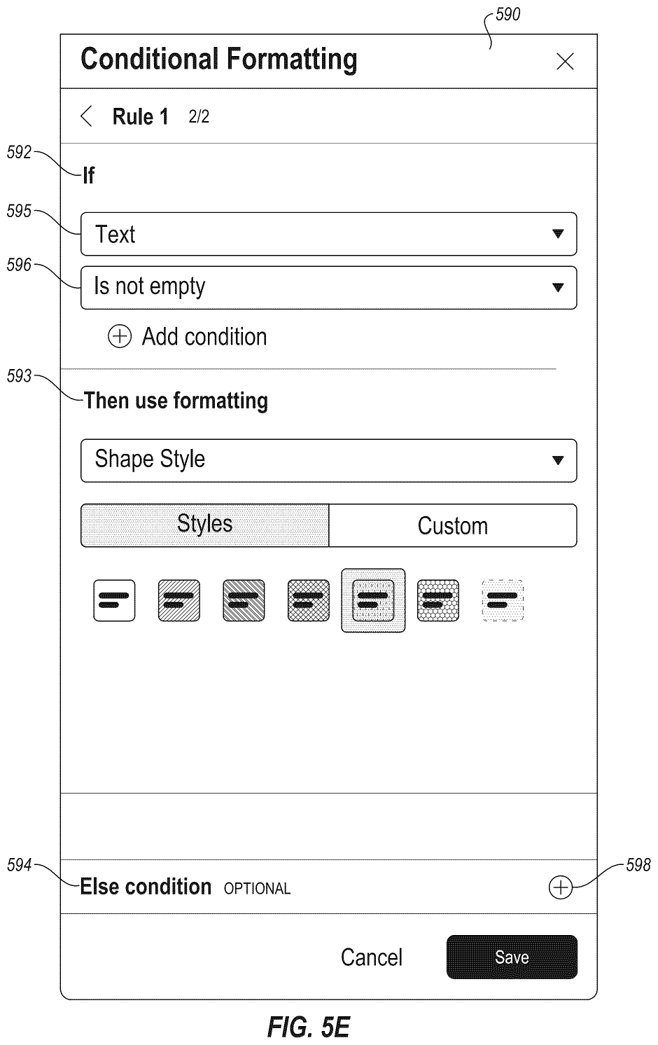

FIG. 5A depicts a graphical user interface of an application with example selections of a conditional formatting rule-creation pop-up window (“conditional formatting window”) 510, according to at least one embodiment of the present disclosure. The user's selection of the “create rule” button 420 in FIG. 4 in the conditional formatting window 410 may result in the display of additional customizations and selections, e.g., within the conditional formatting window 510 in FIG. 5A. The conditional formatting window 510 may allow the user to set an “if” condition 520, a “then” formatting 530, and optionally an “else” condition 540, or even more “else” conditions (not illustrated).

The “if” condition 520 area of the conditional formatting window 510 includes a data source drop down list 550 from which a desired data source may be selected. The data sources within the drop down list 550 are not the same as the data sources discussed with respect to, e.g., FIG. 1. The data sources within the drop down list 550 may refer to different types, pools, or collections of data associated with graphical objects that may be displayed in a drawing canvas. In some embodiments, the selectable data sources within the drop down list 550 include Text, Shape Type, Shape Data, Shape Location, Formula, and/or other data sources. Text may refer to the text displayed within graphical objects. Shape Type may refer to a type of each shape (e.g., decision block, terminal block, etc.). Shape Location may refer to where a shape is located, e.g., relative to other shapes and/or relative to a graphical drawing canvas on which the graphical objects are displayed. Shape Data may refer to all other data (whether or not displayed) associated with the graphical objects. Formula may refer to any formula that may be applied as a condition to the graphical objects. The “if” condition 520 area may include one or more other drop down lists, fields, or other user interface elements depending on the selected data source from the drop down list 550. For example, in response to selection of the “Text” data source from the drop down list 550, the “if” condition area 520 may include a condition drop down list 560 from which the user may select any desired condition, such as “Is empty”, “Is not empty”, “Contains”, or “Does not contain”. If “Contains” or “Does not contain” is selected, the “if” condition 520 area may further include an input field in which the user can enter (e.g., type) a text value that is the subject of the “Contains” or “Does not contain” condition. Selection of other data sources from the drop down list 550 may cause the “if” condition 520 area to include one or more of the same or different drop down lists, fields, or other user interface elements.

The “then” formatting 530 area includes a formatting drop down menu 570 from which a desired formatting type may be selected. In some embodiments, the formatting types within the drop down menu 570 may include Icons, Shape Style, and/or other formatting types. Icons may refer to Icons that may be applied to graphical objects that satisfy the condition specified in the “if” condition 520 area, such as icons of a specified shape, color, or the like. Shape Style may refer to shape formatting that may be applied to graphical objects that satisfy the condition specified in the “if” condition 520 area, such as fill color, line color and/or style, border color and/or style, or the like. The “then” formatting 530 area may include one or more other drop down lists, fields, or other user interface elements depending on the selected formatting type from the drop down list 570. For example in response to selection of the “Icons” formatting type from the drop down list 570, the “then” formatting 530 area may include a type drop down list (not shown) from which the user may select any desired icon type, such as icons from an “Icon Library”, a “Custom Icon”, or a “Text Badge”. In FIG. 5A, the user has selected the “Icons” formatting type from the drop down menu 570.

The “else” condition 540 area includes a button 580 that, when selected, allows the user to add an else condition to the rule currently being created or edited through the conditional. formatting window 510. Selection of the button 580 may allow the user to add either an else condition or an else if condition. Selection of the else condition from the “else” condition 540 area allows the user to specify a formatting or style to apply to any graphical objects that do not satisfy the condition specified in the “if” condition 520. Selection of the else if condition from the “else” condition 540 area allows the user to specify an additional condition (in addition to the one specified in the “if” condition 520 area) and formatting or style (in addition to the one specified in the “then” formatting 530 area) to apply to any graphical objects that both do not satisfy the condition specified in the “if” condition 520 and do satisfy the additional condition. Optionally, a user may add multiple else and/or else if conditions using the “else” condition 540 area.

FIG. 5B depicts the graphical user interface of the application of FIG. 5A with alternative example selections of the conditional formatting window 510, according to at least one embodiment of the present disclosure. In the conditional formatting window 510 of FIG. 5B, the user has selected Shape Style as the formatting type from the drop down list 560 and then may turn on or off a desired Fill, Border, and/or Line formatting using a corresponding toggle button and, for any of the foregoing that are turned on, the user may select a desired color and/or style (e.g., solid, dashed, dot-dash, etc.). In the example of FIG. 5B, both the Fill and Border formatting are turned on, each having a different color, with the Border style being solid with 2 px thickness.

FIGS. 5C and 5D depict the graphical user interface of the application of FIG. 5A with alternative example selections of the conditional formatting window 510, according to at least one embodiment of the present disclosure.

FIG. 5E depicts a graphical user interface of an application with example selections of a conditional formatting rule-creation pop-up window (“conditional formatting window”) 590, according to at least one embodiment of the present disclosure. The user's selection of the “create rule” button 420 in FIG. 4 in the conditional formatting window 410 may result in the display of additional customizations and selections, e.g., within the conditional formatting window 590 in FIG. 5E. The conditional formatting window 590 may be implemented instead of or in addition to the conditional formatting window 510 of FIGS. 5A-5D. Similar to the conditional formatting window 510, the conditional formatting window 590 of FIG. 5E may allow the user to set an “if” condition 592, a “then” formatting 593, and optionally an “else” condition 594, or even more “else” conditions (not illustrated).

The “if” condition 592 area of the conditional formatting window 590 includes a data source drop down list 595 from which a desired data source may be selected. The data sources within the drop down list 595 may be the same as or similar to those discussed with respect to, e.g., FIG. 5A, but are not the same as the data sources discussed with respect to, e.g., FIG. 1. In some embodiments, the selectable data sources within the drop down list 595 include Text, Shape Data, Formula, and/or other data sources. The “if” condition 592 area may include one or more other drop down lists, fields, or other user interface elements depending on the selected data source from the drop down list 595. For example, in response to selection of the “Text” data source from the drop down list 595, the “if” condition area 592 may include a condition drop down list 596 from which the user may select any desired condition, such as “Is empty”, “Is not empty”, “Contains”, or “Does not contain”. If “Contains” or “Does not contain” is selected, the “if” condition 592 area may further include an input field in which the user can enter (e.g., type) a text value that is the subject of the “Contains” or “Does not contain” condition. Selection of other data sources from the drop down list 595 may cause the “if” condition 592 area to include one or more of the same or different drop down lists, fields, or other user interface elements.

The “then” formatting 593 area includes a formatting drop down menu 597 from which a desired formatting type may be selected. In some embodiments, the formatting types within the drop down menu 597 may include Icons, Shape Style, and/or other formatting types, as already described above and/or depicted in FIGS. 5A-5C. In the example of FIG. 5E, however, in response to selection of the Shape Style formatting type, the conditional formatting window 590 may allow the user to select predefined “Styles” or “Custom” Shape Style. Selection of “Custom” (not shown in FIG. 5E) may alter the “then” formatting 593 area to allow selection/specification of specific fill, border, and/or line values as in FIGS. 5B-5C. On the other hand, selection of the “Style” Shape Style may allow selection of any one of two or more predefined styles (seven are depicted in FIG. 5E).

The “else” condition 594 area includes a button 598 that, when selected, allows the user to add an else condition to the rule currently being created or edited through the conditional. formatting window 590. Selection of the button 598 may allow the user to add either an else condition or an else if condition. Selection of the else condition from the “else” condition 594 area allows the user to specify a formatting or style to apply to any graphical objects that do not satisfy the condition specified in the “if” condition 592. Selection of the else if condition from the “else” condition 594 area allows the user to specify an additional condition (in addition to the one specified in the “if” condition 592 area) and formatting or style (in addition to the one specified in the “then” formatting 593 area) to apply to any graphical objects that both do not satisfy the condition specified in the “if” condition 592 and do satisfy the additional condition. Optionally, a user may add multiple else and/or else if conditions using the “else” condition 594 area.

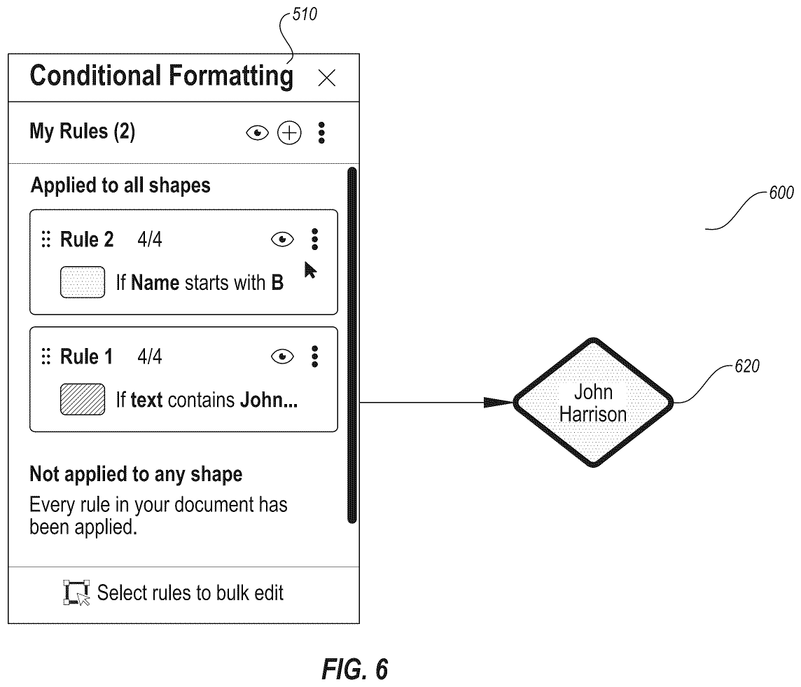

FIG. 6 depicts a graphical user interface 600 of an application according to at least one embodiment of the present disclosure with example selections of a conditional formatting rule-creation pop-up window (conditions window) 610 applied to a graphical object 620. The user can view all rules being applied in one template, i.e., all conditions within the template, and can also view which conditions have been applied, and which conditions have not been applied. The user may also edit individual rules, or “bulk edit” all rules in a particular template, whether a preset template provided by the application or a template created by the user. In at least one embodiment, a user's modification of the styles for a particular condition results in an immediate application of the modification to the affected graphical objects meeting that condition, so the user can see the diagram being changed in real-time.

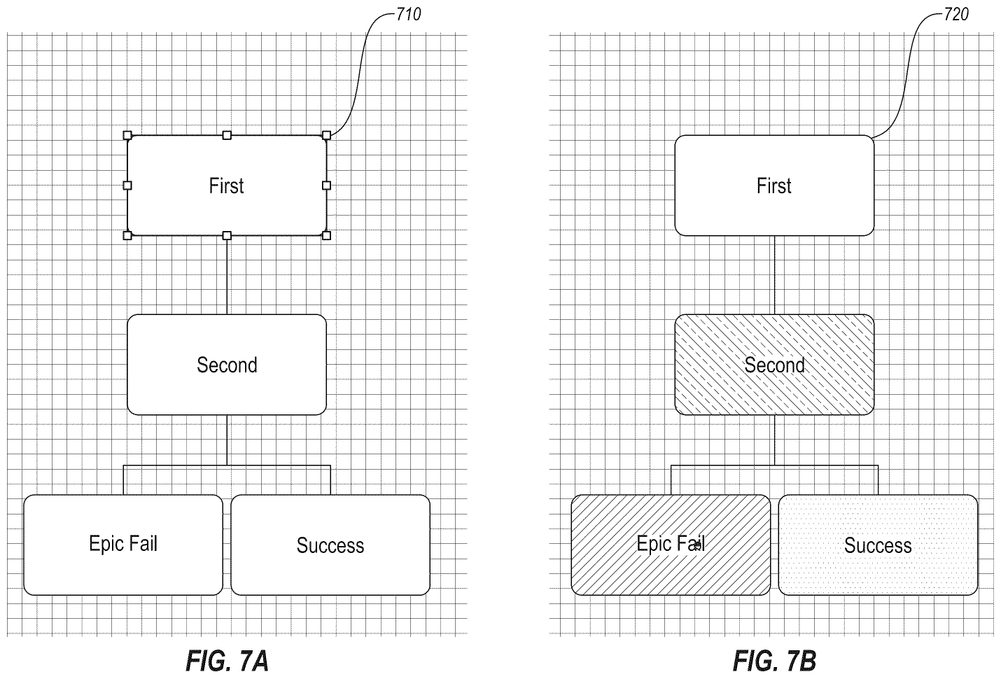

FIG. 7A depicts a diagram 710 created without automatic object formatting in an application, while FIG. 7B depicts a similar diagram 720 having instead been created with automatic object formatting, each according to at least one embodiment of the present disclosure. The diagram 720 created with automatic object formatting applies formatting that matches semantic meaning, e.g., a green-colored graphical object corresponds with the semantic notion of “success,” while a red-colored graphical object corresponds with the semantic notion of “fail” or failure. In FIG. 7B, green fill of the “Success” graphical object is represented by a first fill pattern while red fill of the “Epic Fail” graphical object is represented by a second fill pattern that is different than the first fill pattern. Thus, automatic object formatting as disclosed herein may allow graphical diagrams to provide visual meaning, in addition to or instead of textual meaning.

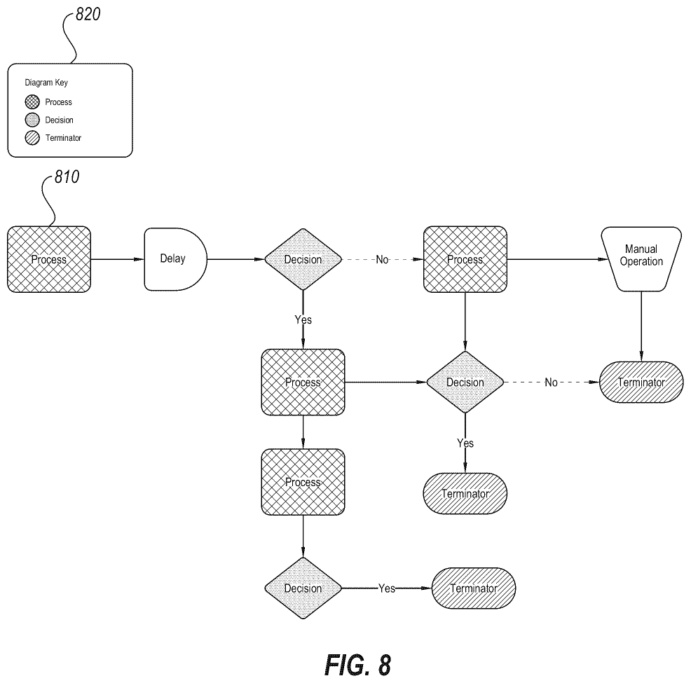

FIG. 8 depicts a more complex diagram 810 created with automatic object formatting in an application according to at least one embodiment of the present disclosure. The diagram 810 is a flowchart or workflow with various blocks and connectors, the blocks and connectors being examples of graphical objects. Automatic object formatting applies the same style consistently throughout the graphical diagram for each diagram node (or block or graphical object) that meets particular conditions. For example, in a diagram depicting a flowchart or workflow, all diagram nodes that meet the “Process” condition (e.g., all diagram nodes that are standard process blocks) are the same shape and color (the color indicated by the fill pattern), all diagram nodes that meet the “Decision” condition (e.g., all diagram nodes that are decision blocks) are the same shape and color, and all diagram nodes that meet the “Terminator” condition (e.g., all diagram nodes that are termination blocks) are the same shape and color, with all connectors and connector lines being uniformly the same size and shape. The conditions template may alternatively or additionally automatically format other types of flowchart blocks, e.g., using a common shape and/or color for all flowchart blocks that are a given type. In some embodiments, the conditions template may automatically create a Diagram Key 820. When new blocks are added to the flowchart, e.g., by the user, the new blocks may have an appropriate style formatting consistently applied by the conditions template without the user having to format or style each block individually and manually or tediously and repeatedly copy and paste. For example, each “Process,” “Decision,” “Terminator,” “Delay,” “Manual Operation,” or other block added to the flowchart of FIG. 8 may be automatically formatted by the conditions template to have the same style (e.g., shape, color, and/or other attribute) as other blocks of the same type.

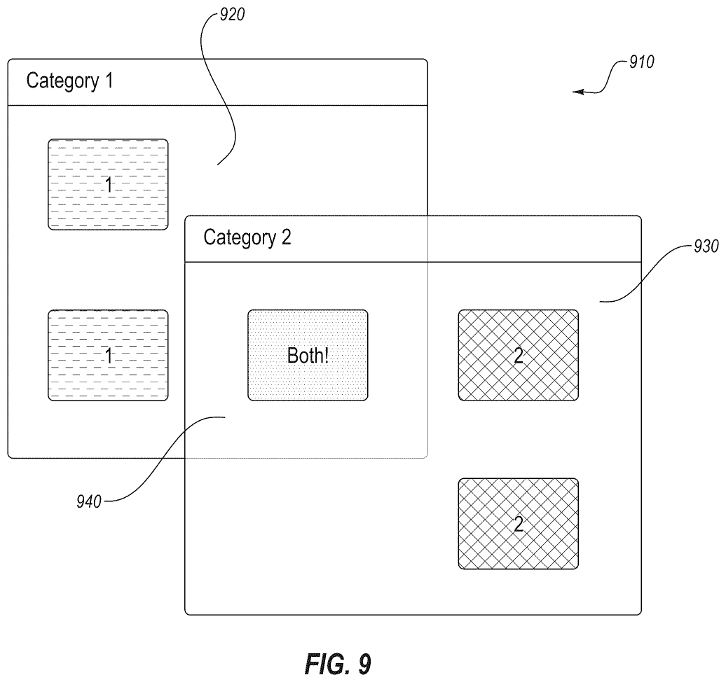

FIG. 9 depicts a Venn diagram 910 created with automatic object formatting in an application according to at least one embodiment of the present disclosure. A Venn diagram typically has two (or more) overlapping graphical objects. The Venn diagram 910 as illustrated has graphical object 920, labeled “Category 1,” overlapping with graphical object 930, labeled “Category 2.” An embodiment in accordance with this application may allow the user to set conditions for the stylistic formatting of Category 1, and another set of conditions for the stylistic formatting of Category 2. The overlapping portion of the two graphical objects 920 and 930 forms an overlapping portion 940, and an embodiment in accordance with this application may allow the user to set yet another set of conditions for the stylistic formatting of the overlapping portion 940. Automatic object formatting may apply conditional style to each of graphical objects 920, 930, and the overlapping portion 940. For example, graphical objects encompassed by the graphical object 920 but not the graphical object 930 may be automatically styled to have a yellow fill color, graphical objects encompassed by the graphical object 930 but not the graphical object 920 may be automatically styled to have a green fill color, and graphical objects within the overlapping portion 940 (i.e., graphical objects encompassed by both the graphical object 920 and the graphical object 930) may be automatically styled to have a blue fill color.

In at least one embodiment, a user can drag and drop the two graphical objects 920 and 930 onto or away from each other (and/or relative to other graphical objects shown in FIG. 9), resize the graphical objects 902, 930, or otherwise alter the content encompassed by the graphical objects 920, 930, which may automatically change the conditions set, and thereby change the styles applied to any data contained within the overlapping portion 940. For example, if the graphical object 920 is moved so that it no longer encompasses either of the three graphical objects shown in FIG. 9 as contained therein, the fill color of the graphical objects shown in FIG. 9 as only being contained in the graphical object 920 may change from yellow to no color (or other color specified for graphical objects not encompassed within graphical object 920, 930) while the fill color of the graphical object shown within the overlapping portion 940 in FIG. 9 may change from blue to green since that graphical object would then only be encompassed by graphical object 930. As another example, if the graphical object 930 is resized so that it encompasses all three graphical objects encompassed by the graphical object 920 in FIG. 9, the fill color of the graphical objects shown in FIG. 9 as only being contained in the graphical object 920 may change from yellow to blue since these graphical objects would then be encompassed by an enlarged overlapping portion 940.

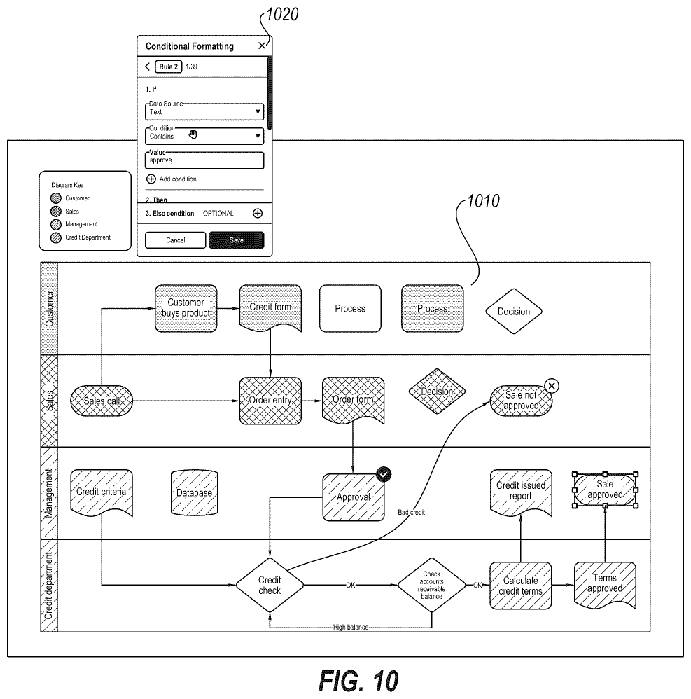

FIG. 10 depicts yet another diagram 1010 created with automatic object formatting in an application according to at least one embodiment of the present disclosure. The diagram 1010 is a swimlane diagram where different graphical objects of a process flow have been assigned to different lanes, each lane representing a different person, group, sub process, or the like. In this example, a condition template may specify, e.g., that all graphical objects in a given swim lane have one or more of the same attributes (e.g., same fill color). The consistent color within a given swim lane in FIG. 10 is represented by a consistent fill pattern in each lane, with exceptions as noted. In particular, in the uppermost lane, two blocks (the third and fifth blocks from the left) have a different fill pattern than the three other blocks in this lane, indicating that these two blocks have a different fill color than the other three blocks. Similarly, in the lowermost lane, two decision blocks have a different fill pattern than the two other blocks in this lane, indicating that the two decision blocks have a different fill color than the other two blocks. The two blocks in the uppermost lane and the two decision blocks in the lowermost lane may have had their fill color changed manually, for example. In other embodiments, the two blocks in the uppermost lane and the two decision blocks in the lowermost lane may satisfy other conditions that are precedent over the condition of being in a given swim lane and that apply a corresponding different attribute.

In some embodiments, moving a graphical object from one lane to another lane may change a corresponding condition (e.g., belonging to a different swim lane) and corresponding attribute (e.g., fill color) of the moved graphical object. For example, if one of the blocks in the third lane from the top is repositioned to be in the lowermost lane, a color fill of the moved block may automatically change from a color fill (e.g., orange) specified in a corresponding condition template for the third lane from the top to a color fill (e.g., red) specified in the corresponding condition template for the lowermost lane.

As illustrated in FIG. 10, a conditional formatting window 1020 can be opened to change the conditions for the entire diagram, or to change the conditions for one or more individual graphical objects. In this manner, graphical diagrams representing large amounts of data, with many nodes, and even innumerable data points, can be formatted and styled easily, automatically, and uniformly. Nodes of the same type, i.e., meeting the same conditions, can have the same formatting applied throughout the entirety of the diagram, or the user can deviate and change the style of one or more nodes individually.

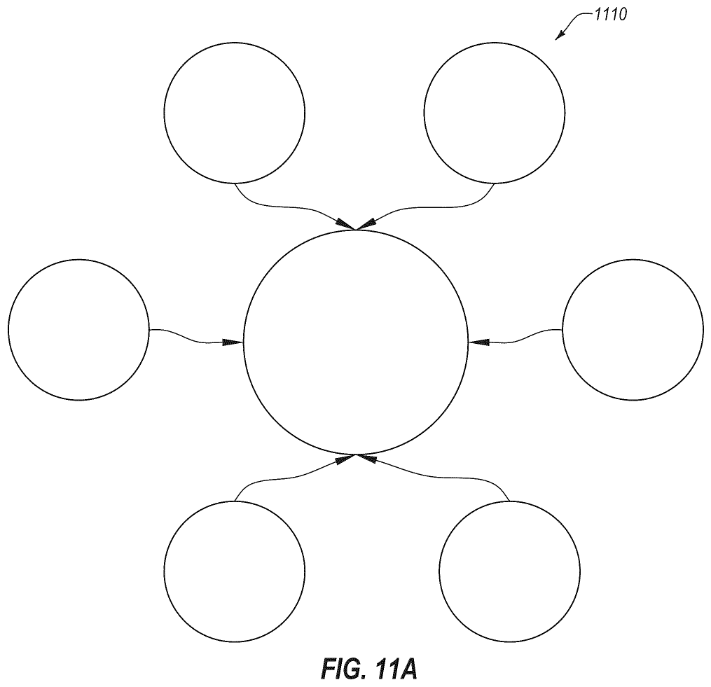

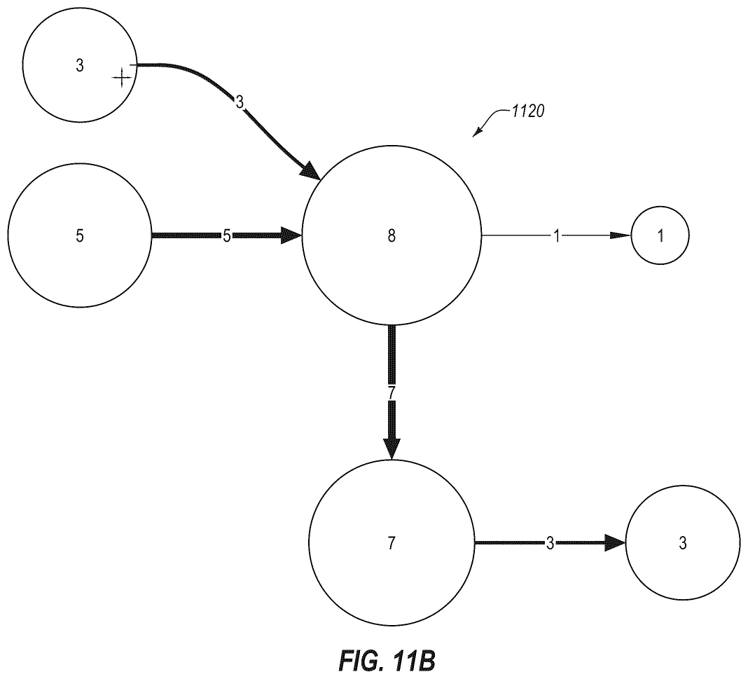

FIGS. 11A and 11B depict Sankey diagrams 1110 and 1120 created with automatic object formatting in an application according to at least one embodiment of the present disclosure. Sankey diagrams are a type of flow diagram in which, typically, a width of connectors (e.g., arrows in FIGS. 11A and 11B is proportional to a flow rate of a specified property. Automatic object formatting in accordance with the application described in the present disclosure allows a user to create Sankey diagrams with ease, where conditional formatting can be applied to create proportional arrows and connectors, and graphical objects or nodes having uniform styles.

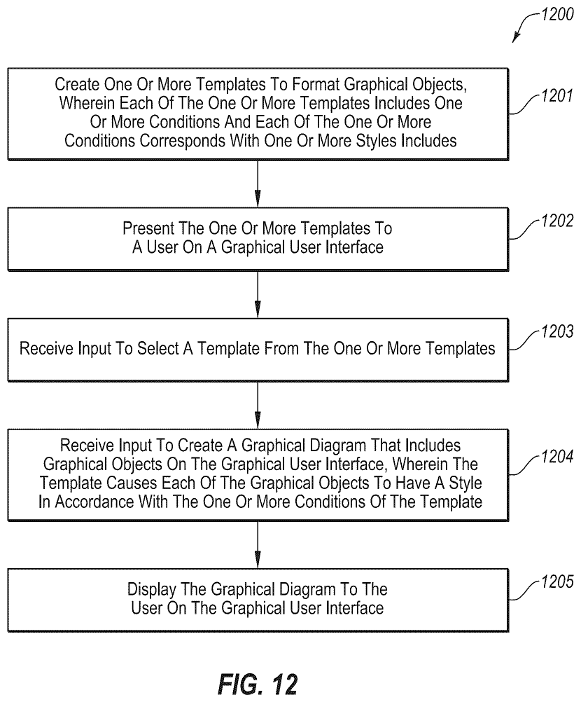

FIG. 12 depicts a flowchart 1200 of a method to create a diagram with automatic object formatting in an application according to at least one embodiment of the present disclosure. The method 1200 may be programmably performed or controlled by a processor in, e.g., a computer and/or server that executes a browser, diagram application, and/or other application to generate graphical diagrams. In an example implementation, the method 1200 may be performed in whole or in part by the server 102 and/or the client device 104 of FIG. 1. The method 200 may include one or more of blocks 1201, 1202, 1203, 1204, and/or 1205.

At block 1201, the method 1200 may include creating one or more templates to format graphical objects. Each of the one or more templates may include one or more conditions and each of the one or more conditions may correspond with one or more styles. In some embodiments, the method 1200 may include receiving user input to create at least one of the one or more templates. The user input may create a new template from scratch, from a pre-existing template that is modified and then saved by the user input, or the like.

Alternatively or additionally, the method 1200 may include providing the one or more templates to format graphical objects. For instance, the one or more templates may be provided within a corresponding application (e.g., the diagram application 114 of FIG. 1) for access by users.

At block 1202, the method 1200 may include presenting the one or more templates to a user on a graphical user interface. The one or more templates may be presented within the graphical user interface in a pop-up menu, drop-down menu, or other menu, e.g., in response to use input to open the menu.

At block 1203, the method 1200 may include receiving input to select a template from the one or more templates. Receiving the input may include receiving a user selection of a template facilitated by a user input device, such as a mouse, keyboard, touch screen, or the like.

At block 1204, the method 1200 may include receiving input to create a graphical diagram that includes graphical objects on the graphical user interface. In some embodiments, the template causes each of the graphical objects to have a style in accordance with the one or more conditions of the template, e.g., as illustrated in and/or described with respect to FIGS. 7B-11B.

Receiving the input to create the graphical diagram at block 1204 may include receiving input to build the graphical diagram one graphical object at a time, e.g., by a user dragging and dropping graphical objects from a sidebar or other menu onto a drawing canvas. Alternatively or additionally, receiving the input to create the graphical diagram may include receiving input to select a diagram template that auto-populates numerous graphical objects in a preconfigured arrangement onto the drawing canvas. A diagram template as used herein is different than other templates described in the context of, e.g., FIGS. 7B-11B. As already indicated, a diagram template may have or insert into the drawing canvas a preconfigured arrangement of graphical objects. In contrast, templates described in the context of, e.g., FIGS. 7B-11B, which may alternatively be referred to as style templates, specify conditions and styles to apply to graphical objects that satisfy the conditions. Alternatively or additionally, the graphical diagram may be created in some other manner.

At block 1205, the method 1200 may include displaying the graphical diagram to the user on the graphical user interface.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

For example, in some embodiments, a user may override one or more automatic styles of the selected template with respect to individual graphical objects (or a simultaneously selected set of two or more graphical objects) by manually selecting a desired graphical object (and/or the set of two or more graphical objects) and manually altering its (or their) style. Alternatively or additionally, the method may include prioritizing conditional formatting rules or other rules embodied by a given template to, e.g., clarify which of two mutually exclusive styles to apply to graphical objects that satisfy both corresponding conditions. As another example, a user may import templates from another document than a document in which the user is currently working.

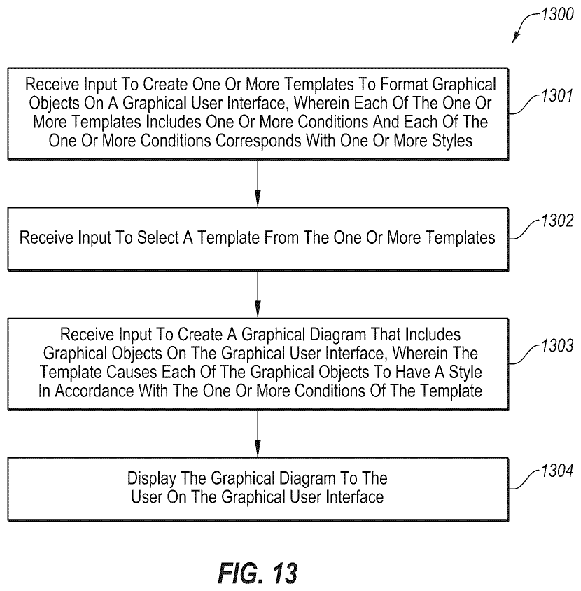

FIG. 13 depicts a flowchart 1300 of another method to create a diagram with automatic object formatting in an application according to at least one embodiment of the present disclosure. The method 1300 may be programmably performed or controlled by a processor in, e.g., a computer and/or server that executes a browser, diagram application, and/or other application to generate graphical diagrams. In an example implementation, the method 1200 may be performed in whole or in part by the server 102 and/or the client device 104 of FIG. 1. The method 200 may include one or more of blocks 1301, 1302, 1303, and/or 1304.

At block 1301, the method may include receiving input to create one or more templates to format graphical objects on a graphical user interface. In some embodiments, each of the one or more templates includes one or more conditions and each of the one or more conditions corresponds with one or more styles.

At block 1302, the method 1300 may include receiving input to select a template from the one or more templates. Receiving the input may include receiving a user selection of a template facilitated by a user input device, such as a mouse, keyboard, touch screen, or the like.

At block 1303, the method 1300 may include receiving input to create a graphical diagram that includes graphical objects on the graphical user interface. In some embodiments, the template causes each of the graphical objects to have a style in accordance with the one or more conditions of the template, e.g., as illustrated in and/or described with respect to FIGS. 7B-11B. Receiving the input to create the graphical diagram at block 1303 may include receiving input to build the graphical diagram one graphical object at a time, e.g., by a user dragging and dropping graphical objects from a sidebar or other menu onto a drawing canvas. Alternatively or additionally, receiving the input to create the graphical diagram may include receiving input to select a diagram template that auto-populates numerous graphical objects in a preconfigured arrangement onto the drawing canvas. Alternatively or additionally, the graphical diagram may be created in some other manner.

At block 1304, the method 1300 may include displaying the graphical diagram to the user on the graphical user interface.

In some embodiments, a user may override one or more automatic styles of the selected template with respect to individual graphical objects (or a simultaneously selected set of two or more graphical objects) by manually selecting a desired graphical object (and/or the set of two or more graphical objects) and manually altering its (or their) style. Alternatively or additionally, the method may include prioritizing conditional formatting rules or other rules embodied by a given template to, e.g., clarify which of two mutually exclusive styles to apply to graphical objects that satisfy both corresponding conditions. As another example, a user may import templates from another document than a document in which the user is currently working.

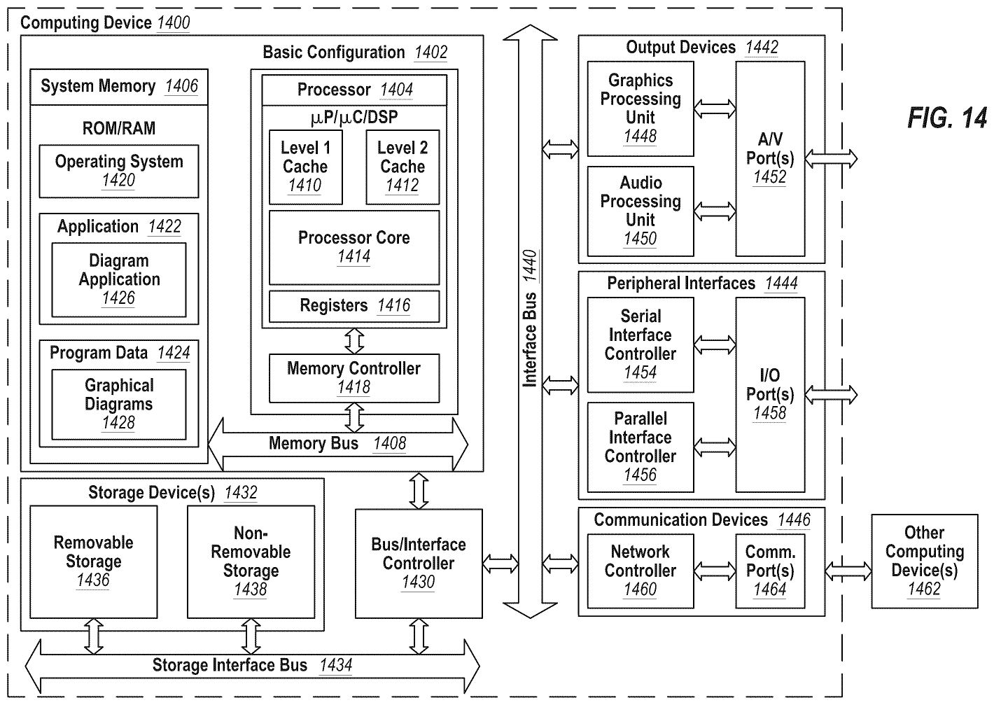

FIG. 14 is a block diagram illustrating an example computing device 1400 that is arranged to generate and display graphical diagrams via automatic object formatting according to at least one embodiment of the present disclosure. The computing device 600 may include, be included in, or otherwise correspond to either or both of the server 102 or the client devices 104, 106, 108 of FIG. 1. In a basic configuration 1402, the computing device 1400 typically includes one or more processors 1404 and a system memory 1406. A memory bus 1408 may be used to communicate between the processor 1404 and the system memory 1406.

Depending on the desired configuration, the processor 1404 may be of any type including, but not limited to, a microprocessor (μP), a microcontroller (μC), a digital signal processor (DSP), or any combination thereof. The processor 1404 may include one or more levels of caching, such as a level one cache 1410 and a level two cache 1412, a processor core 1414, and registers 1416. The processor core 1414 may include an arithmetic logic unit (ALU), a floating point unit (FPU), a digital signal processing core (DSP Core), or any combination thereof. An example memory controller 1418 may also be used with the processor 1404, or in some implementations the memory controller 1418 may include an internal part of the processor 1404.

Depending on the desired configuration, the system memory 1406 may be of any type including volatile memory (such as RAM), nonvolatile memory (such as ROM, flash memory, etc.), or any combination thereof. The system memory 1406 may include an operating system 1420, one or more applications 1422, and program data 1424. The application 1422 may include a diagram application 1426 that is arranged to generate and display graphical diagrams via automatic object formatting according to conditions, rules, and criteria, as described herein. The diagram application 1426 may include, be included in, or otherwise correspond to the application 114 of FIG. 1. The program data 1424 may include graphical diagrams 1426 (which may include, be included in, or otherwise correspond to the graphical diagrams 126 of FIG. 1) as is described herein, structured source data collections (such as structured source data 120 of FIG. 1), models of structured source data (such as models 122 of FIG. 1) and/or other diagram application data. In some embodiments, the application 1422 may be arranged to operate with the program data 1424 on the operating system 1420 such that one or more methods may be provided as described herein.

The computing device 1400 may have additional features or functionality, and additional interfaces to facilitate communications between the basic configuration 1402 and any involved devices and interfaces. For example, a bus/interface controller 1430 may be used to facilitate communications between the basic configuration 1402 and one or more data storage devices 1432 via a storage interface bus 1434. The data storage devices 1432 may be removable storage devices 1436, non-removable storage devices 1438, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 1406, the removable storage devices 1436, and the non-removable storage devices 1438 are examples of computer storage media or non-transitory computer-readable media. Computer storage media or non-transitory computer-readable media includes RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other non-transitory medium which may be used to store the desired information and which may be accessed by the computing device 1400. Any such computer storage media or non-transitory computer-readable media may be part of the computing device 1400.

The computing device 1400 may also include an interface bus 1440 to facilitate communication from various interface devices (e.g., output devices 1442, peripheral interfaces 1444, and communication devices 1446) to the basic configuration 1402 via the bus/interface controller 1430. The output devices 1442 include a graphics processing unit 1448 and an audio processing unit 1450, which may be configured to communicate to various external devices such as a display or speakers via one or more A/V ports 1452. Diagrams, flowcharts, organizational charts, connectors, and/or other graphical objects generated by the diagram application 1426 may be output through the graphics processing unit 1448 to such a display. The peripheral interfaces 1444 include a serial interface controller 1454 or a parallel interface controller 1456, which may be configured to communicate with external devices such as input devices (e.g., keyboard, mouse, pen, voice input device, touch input device, etc.), sensors, or other peripheral devices (e.g., printer, scanner, etc.) via one or more I/O ports 1458. Such input devices may be operated by a user to provide input to the diagram application 1426, which input may be effective to, e.g., generate curved connectors, designate points as designated points of one or more curved connectors, relocate one or more designated points, and/or to accomplish other operations within the diagram application 1426. The communication devices 1446 include a network controller 1460, which may be arranged to facilitate communications with one or more other computing devices 1462 over a network communication link via one or more communication ports 1464.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 1400 may be implemented as a portion of a small-form factor portable (or mobile) electronic device such as a smartphone, a personal data assistant (PDA) or an application-specific device. The computing device 1400 may also be implemented as a personal computer including tablet computer, laptop computer, and/or non-laptop computer configurations, or a server computer including both rack-mounted server computer and blade server computer configurations.

### Example Clauses

Implementation examples are described in the following numbered clauses:

Clause 1. A method to format graphical objects, the method comprising: receiving input to create a style template to automatically format graphical objects on a graphical user interface, including receiving first input to designate a condition and receiving second input to designate a style to apply to any graphical object that satisfies the condition; receiving input to create a graphical diagram comprising a plurality of graphical objects on the graphical user interface; automatically applying the style template to automatically format graphical objects that satisfy the condition, including automatically formatting a first graphical object of the plurality of graphical objects that satisfies the condition to have the style; and displaying the graphical diagram on the graphical user interface with each graphical object that satisfies the condition, including the first graphical object, formatted with the style.

Clause 2. The method of clause 1, wherein the condition is unrelated to text content of the graphical objects.

Clause 3. The method of clause 1, wherein the first input to designate the condition comprises at least one of selection of a data source from among a plurality of data sources, selection of the condition from among one or more conditions corresponding to a selected data source, and an input value associated with a selected condition.

Clause 4. The method of clause 3, wherein the plurality of data sources include at least two of text of the plurality of graphical objects, shape type of the plurality of graphical objects, shape data of the plurality of graphical objects, shape location of the plurality of graphical objects, or a formula.

Clause 5. The method of clause 3, wherein the one or more conditions include at least one of “is empty”, “is not empty”, “contains”, “does not contain”, “is”, “is not”, “starts with”, “ends with”, “is greater than”, “is less than”, “is equal to”, “is not equal to”, “is between”, “is not between”, “is inside of”, “is not inside of”.

Clause 6. The method of clause 1, wherein receiving second input to designate a style to apply to any graphical object that satisfies the condition includes receiving input to select a first predefined style from among a plurality of predefined styles or receiving input to create a custom predefined style.

Clause 7. The method of clause 6, wherein each of the predefined styles specifies at least one of a fill color, a border style, a border weight, or a text color to be applied to any graphical object that satisfies the condition.

Clause 8. The method of clause 1, further comprising: receiving input to edit the style template, including changing the style of the style template from a first style to a second style; and in response to receiving the input to edit the style template, automatically updating the style of each graphical object that satisfies the condition, including the first graphical object, from the first style to the second style.

Clause 9. A non-transitory computer readable storage medium having computer-executable instructions stored thereon that are executable by a processor device to perform or control performance of the method of clause 1.

Clause 10. A method to format graphical objects, comprising: displaying a plurality of graphical objects on a graphical drawing canvas; displaying a plurality of style templates that may be applied to the plurality of graphical objects, each of the style templates having a different predefined style; receiving input to select a first style template of the plurality of style templates; in response to receiving the input to select the first style template, automatically updating a style of a first graphical object of the plurality of graphical objects to match a predefined style of the first style template.

Clause 11. The method of clause 10, wherein the predefined style of the first style template includes at least one of a first fill color, a first border style, a first border weight, and a first text color.

Clause 12. The method of clause 11, wherein automatically updating the style of the first graphical object comprises automatically updating at least one of a fill color of the first graphical object to the first fill color, a border style of the first graphical object to the first border style, a border weight of the first graphical object to the first border weight, or a text color of the first graphical object to the first text color.

Clause 13. The method of clause 10, further comprising: receiving input to edit the first style template, including changing the predefined style of the first style template from a first predefined style to a second predefined style; and in response to receiving the input to edit the first style template, automatically updating the style of the first graphical object from the first predefined style to the second predefined style.

Clause 14. The method of clause 10, wherein the first style template is applied to at least two of the plurality of graphical objects independent of text content of the at least two of the plurality of graphical objects.

Clause 15. The method of clause 10, further comprising: prior to receiving the input to select the first style template of the plurality of style templates, receiving input to select the first graphical object and at least one other graphical object of the plurality of graphical objects; and further in response to receiving the input to select the first style template, automatically updating a style of the at least one other graphical object to match the predefined style of the first style template without updating a style of any of one or more non-selected graphical objects.

Clause 16. A non-transitory computer readable storage medium having computer-executable instructions stored thereon that are executable by a processor device to perform or control performance of the method of clause 10.

Clause 17: A method to automatically format objects of a graphical diagram, the method comprising: creating one or more templates to format a plurality of graphical objects, wherein: each of the one or more templates comprises one or more conditions; and each of the one or more conditions corresponds with one or more styles; presenting the one or more templates to a user on a graphical user interface; receiving input to select a template from the one or more templates; receiving input to create a graphical diagram comprised of a plurality of graphical objects on the graphical user interface, wherein the template causes each of the plurality of graphical objects of the graphical diagram to have a style in accordance with the one or more conditions of the template; and displaying the graphical diagram to the user on the graphical user interface with each of the plurality of graphical objects formatted with a corresponding style.

Clause 18: The method of clause 17, further comprising receiving input to modify at least one of the one or more templates to comprise one or more modified conditions.

Clause 19: The method of clause 17, further comprising receiving input to modify one or more of the plurality of graphical objects to override the one or more conditions of the template.

Clause 20: The method of clause 17, wherein each of the one or more templates corresponds with a graphical diagram type.

Clause 21: The method of clause 20, wherein the graphical diagram type is a Venn diagram.

Clause 22: The method of clause 20, wherein the graphical diagram type is a Sankey diagram.

Clause 23: A method to display a graphical diagram, the method comprising: receiving input to create one or more templates to format a plurality of graphical objects on a graphical user interface, wherein: each of the one or more templates comprises one or more conditions; and each of the one or more conditions corresponds with one or more styles; receiving input to select a template from the one or more templates; receiving input to create a graphical diagram comprised of a plurality of graphical objects on the graphical user interface, wherein the template causes each of the plurality of graphical objects to have a style in accordance with the one or more conditions of the template; and displaying the graphical diagram to the user on the graphical user interface with each of the plurality of graphical objects formatted with a corresponding style.

Clause 24: The method of clause 23, further comprising receiving input to modify at least one of the one or more templates to comprise one or more modified conditions.

Clause 25: The method of clause 23, further comprising receiving input to modify one or more of the plurality of graphical objects to override the one or more conditions of the template.

Clause 26: The method of clause 23, wherein each of the one or more templates corresponds with a graphical diagram type.

Clause 27: The method of clause 26, wherein the graphical diagram type is a Venn diagram.

Clause 28: The method of clause 26, wherein the graphical diagram type is a Sankey diagram.

Clause 29: A non-transitory computer-readable medium having computer-readable instructions stored thereon that are executable by a processor to perform or control performance of operations comprising: receiving input to create one or more templates to format a plurality of graphical objects on a graphical user interface, wherein: each of the one or more templates comprises one or more conditions; and each of the one or more conditions corresponds with one or more styles; receiving input to select a template from the one or more templates; receiving input to create a graphical diagram comprised of a plurality of graphical objects on the graphical user interface, wherein the template causes each of the plurality of graphical objects to have a style in accordance with the one or more conditions of the template; and displaying the graphical diagram on the graphical user interface with each of the plurality of graphical objects formatted with a corresponding style.

Clause 30: The non-transitory computer-readable medium of clause 29, wherein the operations further comprise receiving input to modify at least one of the one or more templates to comprise one or more modified conditions.

Clause 31: The non-transitory computer-readable medium of clause 29, wherein the operations further comprise receiving input to modify one or more of the plurality of graphical w objects to override the one or more conditions of the template.

Clause 32: The non-transitory computer-readable medium of clause 29, wherein each of the one or more templates corresponds with a graphical diagram type.

Clause 33: The non-transitory computer-readable medium of clause 32, wherein the graphical diagram type is a Venn diagram.

Clause 34: The non-transitory computer-readable medium of clause 32, wherein the graphical diagram type is a Sankey diagram.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions to achieve the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Embodiments described herein may be implemented using computer-readable media for carrying or having computer-executable instructions or data structures stored thereon. Such computer-readable media may be any available media that may be accessed by a general-purpose or special-purpose computer. By way of example, such computer-readable media may include non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable media.

Computer-executable instructions may include, for example, instructions and data which cause a general-purpose computer, special-purpose computer, or special-purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method to format graphical objects, the method comprising:
receiving input to create a style template to automatically format graphical objects on a graphical user interface, including receiving first input to designate a condition and receiving second input to designate a style to apply to any graphical object that satisfies the condition;
receiving input to create a graphical diagram comprising a plurality of graphical objects on the graphical user interface;
automatically applying the style template to automatically format graphical objects that satisfy the condition, including automatically formatting a first graphical object of the plurality of graphical objects that satisfies the condition to have the style; and
displaying the graphical diagram on the graphical user interface with each graphical object that satisfies the condition, including the first graphical object, formatted with the style.

2. The method of claim 1, wherein the condition is unrelated to text content of the graphical objects.

3. The method of claim 1, wherein the first input to designate the condition comprises at least one of selection of a data source from among a plurality of data sources, selection of the condition from among one or more conditions corresponding to a selected data source, and an input value associated with a selected condition.

4. The method of claim 3, wherein the plurality of data sources include at least two of text of the plurality of graphical objects, shape type of the plurality of graphical objects, shape data of the plurality of graphical objects, shape location of the plurality of graphical objects, or a formula.

5. The method of claim 3, wherein the one or more conditions include at least one of “is empty”, “is not empty”, “contains”, “does not contain”, “is”, “is not”, “starts with”, “ends with”, “is greater than”, “is less than”, “is equal to”, “is not equal to”, “is between”, “is not between”, “is inside of”, “is not inside of”.

6. The method of claim 1, wherein receiving second input to designate a style to apply to any graphical object that satisfies the condition includes receiving input to select a first predefined style from among a plurality of predefined styles or receiving input to create a custom predefined style.

7. The method of claim 6, wherein each of the predefined styles specifies at least one of a fill color, a border style, a border weight, or a text color to be applied to any graphical object that satisfies the condition.

8. The method of claim 1, further comprising:
receiving input to edit the style template, including changing the style of the style template from a first style to a second style; and
in response to receiving the input to edit the style template, automatically updating the style of each graphical object that satisfies the condition, including the first graphical object, from the first style to the second style.

9. A non-transitory computer readable storage medium having computer-executable instructions stored thereon that are executable by a processor device to perform or control performance of the method of claim 1.

10. A method to format graphical objects, the method comprising:
displaying a plurality of graphical objects on a graphical drawing canvas;
displaying a plurality of style templates that may be applied to the plurality of graphical objects, each of the style templates having a different predefined style;
receiving input to select a first style template of the plurality of style templates;
in response to receiving the input to select the first style template, automatically updating a style of a first graphical object of the plurality of graphical objects to match a predefined style of the first style template.

11. The method of claim 10, wherein the predefined style of the first style template includes at least one of a first fill color, a first border style, a first border weight, and a first text color.

12. The method of claim 11, wherein automatically updating the style of the first graphical object comprises automatically updating at least one of a fill color of the first graphical object to the first fill color, a border style of the first graphical object to the first border style, a border weight of the first graphical object to the first border weight, or a text color of the first graphical object to the first text color.

13. The method of claim 10, further comprising:
receiving input to edit the first style template, including changing the predefined style of the first style template from a first predefined style to a second predefined style; and
in response to receiving the input to edit the first style template, automatically updating the style of the first graphical object from the first predefined style to the second predefined style.

14. The method of claim 10, wherein the first style template is applied to at least two of the plurality of graphical objects independent of text content of the at least two of the plurality of graphical objects.

15. The method of claim 10, further comprising:
prior to receiving the input to select the first style template of the plurality of style templates, receiving input to select the first graphical object and at least one other graphical object of the plurality of graphical objects; and
further in response to receiving the input to select the first style template, automatically updating a style of the at least one other graphical object to match the predefined style of the first style template without updating a style of any of one or more non-selected graphical objects.

16. A non-transitory computer readable storage medium having computer-executable instructions stored thereon that are executable by a processor device to perform or control performance of the method of claim 10.

17. A method to automatically format objects of a graphical diagram, the method comprising:
creating one or more templates to format a plurality of graphical objects, wherein:
each of the one or more templates comprises one or more conditions; and
each of the one or more conditions corresponds with one or more styles;
presenting the one or more templates to a user on a graphical user interface;
receiving input to select a template from the one or more templates;
receiving input to create a graphical diagram comprised of a plurality of graphical objects on the graphical user interface, wherein the template causes each of the plurality of graphical objects of the graphical diagram to have a style in accordance with the one or more conditions of the template; and
displaying the graphical diagram to the user on the graphical user interface with each of the plurality of graphical objects formatted with a corresponding style.

18. The method of claim 17, further comprising receiving input to modify at least one of the one or more templates to comprise one or more modified conditions.

19. The method of claim 17, further comprising receiving input to modify one or more of the plurality of graphical objects to override the one or more conditions of the template.

20. The method of claim 17, wherein each of the one or more templates corresponds with a graphical diagram type selected from Venn diagram or Sankey diagram.
